(19) United States
(12) Patent Application Publication
(10) Pub. No.: US 2025/0370688 A1
(43) Pub. Date: Dec. 4, 2025

(54) INFORMATION PROCESSING APPARATUS AND CONTROL METHOD

(71) Applicant: Lenovo (Singapore) Pte. Ltd., Singapore (SG)

(72) Inventor: Yoshinori Ito, Kanagawa (JP)

(73) Assignee: Lenovo (Singapore) Pte. Ltd., Singapore (SG)

(21) Appl. No.: 18/975,356

(22) Filed: Dec. 10, 2024

(30) Foreign Application Priority Data
May 30, 2024 (JP) 2024-087993

(51) Int. Cl. G06F 3/14

(52) U.S. Cl. CPC G06F 3/1423

(57) ABSTRACT

An information processing apparatus performs control of arranging and displaying the windows of a running application in a screen area of a display. For example, the information processing apparatus performs a display control process of arranging the windows by splitting the screen area of the display into a plurality of display areas, and in the display control process, when arranging a first window of the windows in one display area of the plurality of display areas, arranges thumbnail images corresponding to one or a plurality of second windows other than the first window in a display area other than the one display area of the plurality of display areas, and determines the display area in which the thumbnail images are to be arranged with respect to the one display area in which the first window is to be arranged, in a certain arrangement order.

### CROSS-REFERENCE TO RELATED APPLICATIONS

This application claims priority to Japanese Patent Application No. 2024-087993 filed on May 30, 2024, the contents of which are hereby incorporated herein by reference in their entirety.

### BACKGROUND OF THE INVENTION

### Field of the Invention

The present invention relates to an information processing apparatus and a control method.

### Description of the Related Art

There is an information processing apparatus that is capable of splitting the screen area of a display into a plurality of display areas to display windows of an application or the like in respective display area. For example, Japanese Patent No. 7440672 discloses an information processing apparatus in which a flexible display is provided across a first chassis and a second chassis that can be rotated by a hinge mechanism, and when the first chassis and second chassis are in a bent form or a flat form, the screen area of the flexible display can be used as one display area or as two split display areas.

In addition, in recent years, there is a snap function that allows a user to select any display area within a layout in which the screen area is split into a plurality of display areas, such as two, three, or four parts, and arrange windows of an application according to the operation of the user. For example, the user can select a display area of any layout while performing a drag operation on any window displayed on a display to snap (arrange) the window in the display area of the selected layout.

In addition, for example, thumbnail images of other windows of the running application are displayed in a display area other than the display area in which the window is arranged so that the thumbnail images can be listed, and when the user selects a thumbnail image, the selected window can be displayed in the display area in which the thumbnail image is displayed.

### SUMMARY OF THE INVENTION

However, when a window is arranged in any display area within a layout in which a screen area is split into a plurality of display areas as described above, if thumbnail images of other running windows are to be arranged and displayed in other display areas, a rule for determining an order in which the display areas in which thumbnail images are arranged is difficult to understand, depending on the display state at the time, and the user may not be able to arrange the windows as intended, such as arranging the thumbnail images sequentially in the display areas next to the one in which the window is arranged, or, if a window is arranged in the next display area, skipping that display area and arranging the thumbnail images in the display area after that display area, or selecting display areas in which no windows are displayed in a Z-shaped order and arranging the thumbnail images therein.

One of the objects of the present invention is to provide an information processing apparatus and a control method that make it easy to arrange a window as intended by a user in a layout in which a screen area is split into a plurality of display areas.

An information processing apparatus according to the first aspect of the present invention includes a memory configured to store a program of an application, and a processor configured to perform control of arranging and displaying windows of the running application in a screen area of a display by executing the program of the application stored in the memory, in which the processor is configured to: perform a display control process of arranging the windows by splitting the screen area of the display into a plurality of display areas, and in the display control process, when arranging a first window of the windows in one display area of the plurality of display areas, arrange thumbnail images corresponding to one or a plurality of second windows other than the first window in a display area other than the one display area of the plurality of display areas, and determine the display area in which the thumbnail images are to be arranged with respect to the one display area in which the first window is to be arranged, in a certain arrangement order.

In the information processing apparatus, in the display control process, even when any of the windows is already arranged in the display area in which the thumbnail images are to be arranged, which is determined in the certain arrangement order, the processor may preferentially arrange the thumbnail images in the display area.

In the information processing apparatus, the certain arrangement order may be an order in a clockwise order.

In the information processing apparatus, the certain arrangement order may be an order in a counterclockwise order.

In the information processing apparatus, in the display control process, when the windows are arranged by splitting the screen area of the display into two upper and lower display areas, the processor may arrange the thumbnail images in a lower second display area of the two split display areas when arranging the first window in an upper first display area, and arrange the thumbnail images in the first display area when arranging the first window in the second display area.

In the information processing apparatus, in the display control process, when the windows are arranged by splitting the screen area of the display into two left and right display areas, the processor may arrange the thumbnail images in a right second display area of the two split display areas when arranging the first window in a left first display area, and arrange the thumbnail images in the first display area when arranging the first window in the second display area.

In the information processing apparatus, in the display control process, when the windows are arranged by splitting the screen area of the display into three display areas by splitting the screen area into two upper and lower display areas and further splitting the split lower display area into two display areas, the processor may arrange the thumbnail images in a lower right second display area of the three split display areas when arranging the first window in an upper first display area, arrange the thumbnail images in a lower left third display area when arranging the first window in the second display area, and arrange the thumbnail images in the first display area when arranging the first window in the third display area.

In the information processing apparatus, in the display control process, when the windows are arranged by splitting the screen area of the display into three display areas by splitting the screen area into two upper and lower display areas and further splitting the split lower display area into two display areas, the processor may arrange the thumbnail images in a lower left second display area of the three split display areas when arranging the first window in an upper first display area, arrange the thumbnail images in a lower right third display area when arranging the first window in the second display area, and arrange the thumbnail images in the first display area when arranging the first window in the third display area.

In the information processing apparatus, in the display control process, when the windows are arranged by splitting the screen area of the display into three display areas by splitting the screen area into two upper and lower display areas and further splitting the split upper display area into two display areas, the processor may arrange the thumbnail images in an upper right second display area of the three split display areas when arranging the first window in an upper left first display area, arrange the thumbnail images in a lower third display area when arranging the first window in the second display area, and arrange the thumbnail images in the first display area when arranging the first window in the third display area.

In the information processing apparatus, in the display control process, when the windows are arranged by splitting the screen area of the display into three display areas by splitting the screen area into two upper and lower display areas and further splitting the split upper display area into two display areas, the processor may arrange the thumbnail images in a lower second display area of the three split display areas when arranging the first window in an upper left first display area, arrange the thumbnail images in an upper right third display area when arranging the first window in the second display area, and arrange the thumbnail images in the first display area when arranging the first window in the third display area.

In the information processing apparatus, in the display control process, when the windows are arranged by splitting the screen area of the display into three display areas by splitting the screen area into two left and right display areas and further splitting the split right display area into two display areas, the processor may arrange the thumbnail images in a right upper second display area of the three split display areas when arranging the first window in a left first display area, arrange the thumbnail images in a right lower third display area when arranging the first window in the second display area, and arrange the thumbnail images in the first display area when arranging the first window in the third display area.

In the information processing apparatus, in the display control process, when the windows are arranged by splitting the screen area of the display into three display areas by splitting the screen area into two left and right display areas and further splitting the split right display area into two display areas, the processor may arrange the thumbnail images in a right lower second display area of the three split display areas when arranging the first window in a left first display area, arrange the thumbnail images in a right upper third display area when arranging the first window in the second display area, and arrange the thumbnail images in the first display area when arranging the first window in the third display area.

In the information processing apparatus, in the display control process, when the windows are arranged by splitting the screen area of the display into three display areas by splitting the screen area into two left and right display areas and further splitting the split left display area into two display areas, the processor may arrange the thumbnail images in a right second display area of the three split display areas when arranging the first window in a left upper first display area, arrange the thumbnail images in a left lower third display area when arranging the first window in the second display area, and arrange the thumbnail images in the first display area when arranging the first window in the third display area.

In the information processing apparatus, in the display control process, when the windows are arranged by splitting the screen area of the display into three display areas by splitting the screen area into two left and right display areas and further splitting the split left display area into two display areas, the processor may arrange the thumbnail images in a left lower second display area of the three split display areas when arranging the first window in a left upper first display area, arrange the thumbnail images in a right third display area when arranging the first window in the second display area, and arrange the thumbnail images in the first display area when arranging the first window in the third display area.

In the information processing apparatus, in the display control process, when the windows are arranged by splitting the screen area of the display into four upper, lower, left, and right display areas, the processor may arrange the thumbnail images in a right upper second display area of the four split display areas when arranging the first window in a left upper first display area, arrange the thumbnail images in a right lower third display area when arranging the first window in the second display area, arrange the thumbnail images in a left lower fourth display area when arranging the first window in the third display area, and arrange the thumbnail images in the first display area when arranging the first window in the fourth display area.

In the information processing apparatus, in the display control process, when the windows are arranged by splitting the screen area of the display into four upper, lower, left, and right display areas, the processor may arrange the thumbnail images in a left lower second display area of the four split display areas when arranging the first window in a left upper first display area, arrange the thumbnail images in a right lower third display area when arranging the first window in the second display area, arrange the thumbnail images in a right upper fourth display area when arranging the first window in the third display area, and arrange the thumbnail images in the first display area when arranging the first window in the fourth display area.

In the information processing apparatus, in the display control process, when the windows are arranged by splitting the screen area of the display into three display areas in a left-right direction, the processor may arrange the thumbnail images in a central second display area of the three split display areas when arranging the first window in a left first display area, arrange the thumbnail images in a right third display area when arranging the first window in the second display area, and arrange the thumbnail images in the first display area when arranging the first window in the third display area.

In the information processing apparatus, in the display control process, when the windows are arranged by splitting the screen area of the display into three display areas in a left-right direction, the processor may arrange the thumbnail images in a central second display area of the three split display areas when arranging the first window in a right first display area, arrange the thumbnail images in a left third display area when arranging the first window in the second display area, and arrange the thumbnail images in the first display area when arranging the first window in the third display area.

In the information processing apparatus, in the display control process, when the windows are arranged by splitting the screen area of the display into three display areas in an up-down direction, the processor may arrange the thumbnail images in a central second display area of the three split display areas when arranging the first window in an upper first display area, arrange the thumbnail images in a lower third display area when arranging the first window in the second display area, and arrange the thumbnail images in the first display area when arranging the first window in the third display area.

In the information processing apparatus, in the display control process, when the windows are arranged by splitting the screen area of the display into three display areas in an up-down direction, the processor may arrange the thumbnail images in a central second display area of the three split display areas when arranging the first window in a lower first display area, arrange the thumbnail images in an upper third display area when arranging the first window in the second display area, and arrange the thumbnail images in the first display area when arranging the first window in the third display area.

In addition, a control method according to the second aspect of the present invention in an information processing apparatus including a memory configured to store a program of an application, and a processor configured to perform control of arranging and displaying windows of the running application in a screen area of a display by executing the program of the application stored in the memory, the method including: via the processor, a step of splitting the screen area of the display into a plurality of display areas and arranging a first window of the windows in one display area of the plurality of display areas; and a step of arranging thumbnail images corresponding to one or a plurality of second windows other than the first window in a display area other than the one display area of the plurality of display areas, in which the display area in which the thumbnail images are to be arranged is determined in a certain arrangement order with respect to the one display area in which the first window is to be arranged.

According to the above-described aspects of the present invention, it is possible to easily arrange a window in a layout in which the screen area is split into a plurality of display areas as intended by a user.

### BRIEF DESCRIPTION OF THE DRAWINGS

FIG. 1 is a perspective view illustrating an appearance of an information processing apparatus according to a first embodiment.

FIG. 2 is a side view illustrating an example of the information processing apparatus in a bent form according to the first embodiment.

FIG. 3 is a side view illustrating an example of the information processing apparatus in a flat form according to the first embodiment.

FIG. 4 is a view illustrating specific examples of various display modes of the information processing apparatus according to the first embodiment.

FIGS. 5(A) and 5(B) are views illustrating an example of display control when switching from a one-screen mode to a two-screen mode according to the first embodiment.

FIGS. 6(A) and 6(B) are views illustrating a display example of layout selection icons according to the first embodiment.

FIG. 7 is a view illustrating an example of a configuration in which the information processing apparatus according to the first embodiment is connected to an external display.

FIG. 8 is a view illustrating a display example of a display selection icon according to the first embodiment.

FIG. 9 is a view illustrating a selection example of the display selection icon according to the first embodiment.

FIG. 10 is a view illustrating a display example when a layout (display area) is selected by using the layout selection icons according to the first embodiment.

FIG. 11 is a view illustrating a display example when a display position of a window is changed in response to completion of a drag operation according to the first embodiment.

FIGS. 12(A) and 12(B) are views illustrating a first example of a rule for arranging thumbnail images according to the first embodiment.

FIGS. 13(A) and 13(B) are views illustrating a second example of the rule for arranging the thumbnail images according to the first embodiment.

FIGS. 14(A)-(C) are views illustrating a third example of the rule for arranging the thumbnail images according to the first embodiment.

FIGS. 15(A) and 15(B) are views illustrating a fourth example of the rule for arranging the thumbnail images according to the first embodiment.

FIGS. 16(A) and 16(B) are views illustrating a fifth example of the rule for arranging the thumbnail images according to the first embodiment.

FIGS. 17(A)-(C) are views illustrating a sixth example of the rule for arranging the thumbnail images according to the first embodiment.

FIG. 18 is a block view illustrating an example of a hardware configuration of the information processing apparatus according to the first embodiment.

FIG. 19 is a block view illustrating an example of a functional configuration of the information processing apparatus according to the first embodiment.

FIG. 20 is a flowchart illustrating an example of a display layout change process according to the first embodiment.

FIGS. 21(A)-(D) are views illustrating another example of the rule for arranging the thumbnail images according to the first embodiment.

FIGS. 22(A)-(C) are views illustrating a first example of a rule for arranging thumbnail images according to a second embodiment.

FIGS. 23(A)-(C) are views illustrating a second example of the rule for arranging the thumbnail images according to the second embodiment.

FIGS. 24(A)-(C) are views illustrating a third example of the rule for arranging the thumbnail images according to the second embodiment.

FIGS. 25(A)-(C) are views illustrating a fourth example of the rule for arranging the thumbnail images according to the second embodiment.

FIGS. 26(A)-(D) are views illustrating a fifth example of the rule for arranging the thumbnail images according to the second embodiment.

FIGS. 27(A)-(C) are views illustrating a first example of a rule for arranging thumbnail images according to a third embodiment.

FIGS. 28(A)-(C) are views illustrating a second example of the rule for arranging the thumbnail images according to the third embodiment.

FIGS. 29(A)-(C) are views illustrating a third example of the rule for arranging the thumbnail images according to the third embodiment.

FIGS. 30(A)-(C) are views illustrating a fourth example of the rule for arranging the thumbnail images according to the third embodiment.

### DETAILED DESCRIPTION OF THE INVENTION

Hereinafter, embodiments of the present invention will be described with reference to the accompanying drawings.

### First Embodiment

### [Appearance of Information Processing Apparatus]

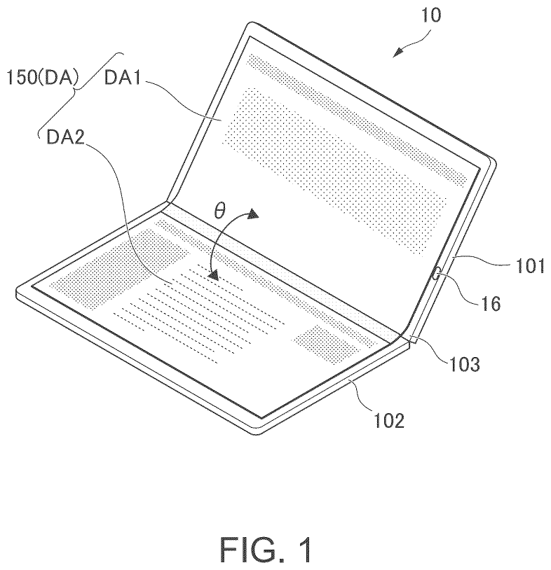

FIG. 1 is a perspective view illustrating the appearance of an information processing apparatus 10 according to the present embodiment. The information processing apparatus 10 according to the present embodiment is a clamshell (laptop) personal computer (PC). The information processing apparatus 10 is provided with a first chassis 101, a second chassis 102, and a hinge mechanism 103. The first chassis 101 and the second chassis 102 are chassis having a substantially quadrangular plate shape (for example, flat plate shape). One of side surfaces of the first chassis 101 and one of side surfaces of the second chassis 102 are coupled (connected) via the hinge mechanism 103, and the first chassis 101 and the second chassis 102 are relatively rotatable around a rotation axis formed by the hinge mechanism 103. A state in which an opening angle θ around the rotation axis of the first chassis 101 and the second chassis 102 is about 0° is a state in which the first chassis 101 and the second chassis 102 overlap with each other and are closed. A state in which the first chassis 101 and the second chassis 102 are closed will be referred to as a “closed state”. In the closed state, surfaces of the first chassis 101 and the second chassis 102 facing each other will be referred to as the respective “inner surfaces”, and surfaces opposite to the inner surfaces will be referred to as “outer surfaces”. The opening angle θ can also be referred to as an angle formed by the inner surface of the first chassis 101 and the inner surface of the second chassis 102. A state in which the first chassis 101 and the second chassis 102 are opened with respect to the closed state will be referred to as an “open state”. The open state is a state in which the first chassis 101 and the second chassis 102 are relatively rotated until the opening angle θ exceeds a preset threshold value (for example, 10°).

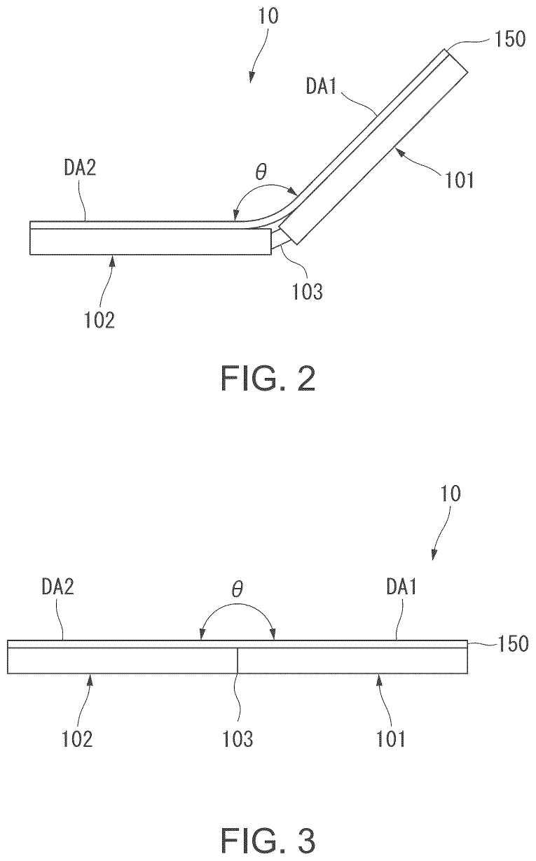

The information processing apparatus 10 is provided with a camera 16 and a display 150. The camera 16 is provided on the inner surface of the first chassis 101. The display 150 is provided over the inner surface of the first chassis 101 and the inner surface of the second chassis 102. The camera 16 is provided in, for example, an outer portion of a screen area of the display 150 on the inner surface of the first chassis 101, and can image a user or the like who exists on the side facing the display 150. The display 150 is a flexible display that can be bent according to the opening angle θ due to the relative rotation of the first chassis 101 and the second chassis 102 (see FIGS. 2 and 3). An organic EL display or the like is used as the flexible display. The information processing apparatus 10 can control display of an entire screen area of the display 150 as one display area DA in a one-screen configuration, and can also control display by splitting the entire screen area of the display 150 into two display areas, a first display area DA1 and a second display area DA2, in a two-screen configuration. Here, the first display area DA1 and the second display area DA2 are the display areas that do not overlap with each other. Here, among the screen areas of the display 150, a display area corresponding to the inner surface side of the first chassis 101 is defined as the first display area DA1, and a display area corresponding to the inner surface side of the second chassis 102 is defined as the second display area DA2. In the following description, a display mode in which display is controlled with the one-screen configuration will be referred to as a “one-screen mode”, and a display mode in which display is controlled with the two-screen configuration will be referred to as a “two-screen mode”.

A touch sensor is provided on the screen area of the display 150. The information processing apparatus 10 can detect a touch operation on the screen area of the display 150. By bringing the information processing apparatus 10 into an open state, the user can visually recognize display of the display 150 provided on the inner surface of each of the first chassis 101 and the second chassis 102, or can perform the touch operation on the display 150, and thus can use the information processing apparatus 10.

Hereinafter, a usage form and the screen mode of the information processing apparatus 10 will be described in detail. First, the usage forms of the information processing apparatus 10 are classified into a bent form in which the first chassis 101 and the second chassis 102 are bent according to the opening angle θ between the first chassis 101 and the second chassis 102, and a flat form in which the first chassis 101 and the second chassis 102 are not bent. In the following description, the bent form in which the first chassis 101 and the second chassis 102 are bent will be simply referred to as a “bent form”, and the flat form in which the first chassis 101 and the second chassis 102 are not bent will be simply referred to as a “flat form”. In the bent form, the display 150 provided over the first chassis 101 and the second chassis 102 is also in the bent form. In the flat form, the display 150 is also in the flat state.

FIG. 2 is a side view illustrating an example of the information processing apparatus 10 in the bent form. The display 150 is arranged over (across) the first chassis 101 and the second chassis 102. The screen area (display area DA illustrated in FIG. 1) of the display 150 can be folded (bent) with a portion corresponding to the hinge mechanism 103 as a crease, and the display area on the first chassis 101 side is illustrated as the first display area DA1 and the display area on the second chassis 102 side is illustrated as the second display area DA2 with the crease as a boundary. The display 150 is bent according to the rotation (opening angle θ) of the first chassis 101 and the second chassis 102. It is determined whether or not the information processing apparatus 10 is in the bent form according to the opening angle θ. As an example, in a case in which 10°<θ<170°, it is determined that the information processing apparatus 10 is in the bent form. This state corresponds to the usage form such as a so-called clamshell mode or book mode.

FIG. 3 is a side view illustrating an example of the information processing apparatus 10 in a flat form. It is typically determined that the information processing apparatus 10 is in the flat form in a case in which the opening angle θ is 180°, but as an example, it may be determined that the information processing apparatus 10 is in the flat form in a case in which 170°≤θ≤180°. For example, in a case in which the opening angle θ between the first chassis 101 and the second chassis 102 is 180°, the display 150 is also in the flat state. This state corresponds to the usage form called a so-called tablet mode.

### [Description of Display Mode]

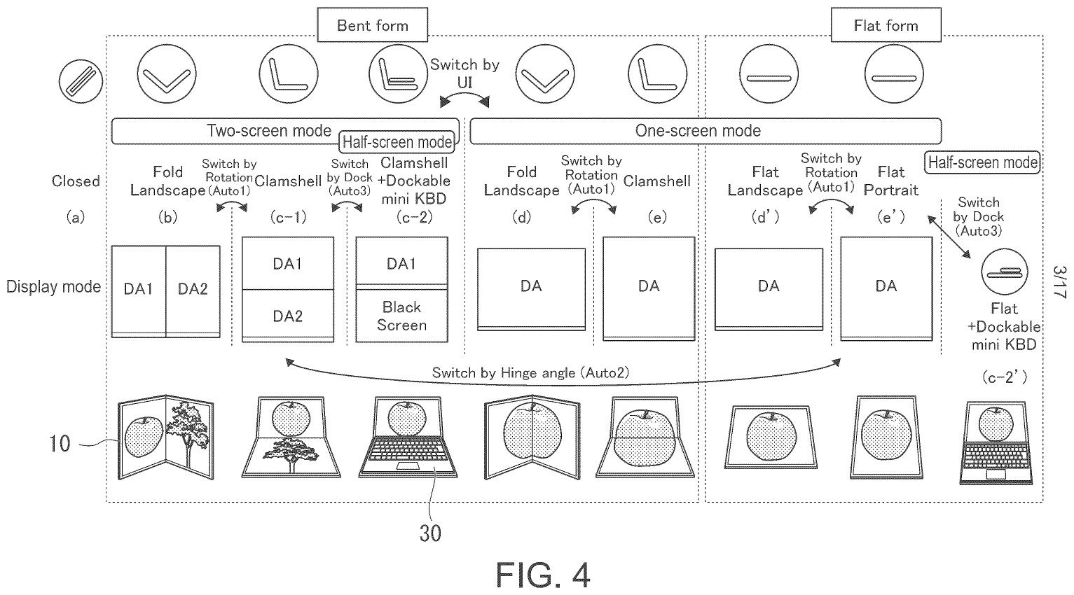

Hereinafter, the display modes according to various usage forms of the information processing apparatus 10 will be described in detail with reference to FIG. 4. FIG. 4 is a view illustrating specific examples of various display modes of the information processing apparatus 10 according to the present embodiment. The information processing apparatus 10 has different display modes according to the usage forms classified according to the opening angle θ between the first chassis 101 and the second chassis 102, a posture (orientation) of the information processing apparatus 10, whether the one-screen mode is used or the two-screen mode is used, and the like. The one-screen will also be called a single screen, and the two-screen will also be called a split screen, a dual screen, or the like.

A display mode (a) when the first chassis 101 and the second chassis 102 are in the closed state (Closed) as the usage form. In this closed state, the information processing apparatus 10 is, for example, in a standby state such as a sleep or suspended state (hibernation), and the display 150 is in a display-off state. The standby state such as the sleep or suspended state (hibernation) corresponds to S3 or S4 of a power supply state of a system defined by, for example, an advanced configuration and power interface (ACPI).

A display mode (b) is a display mode when the usage form is the bent form, and the two-screen mode is used in which display is controlled such that the screen area of the display 150 is split into the two display areas, the first display area DA1 and the second display area DA2. The orientation of the information processing apparatus 10 is a portrait orientation such that the first display area DA1 and the second display area DA2 are in a portrait orientation and are horizontally arranged from side to side. The portrait orientation of the display area is an orientation in which a long side of four sides of a rectangular display area is in a vertical direction and a short side is in a horizontal direction. In a case in which the display area is in the portrait orientation, a display orientation is also the portrait orientation, and display is performed in an orientation in which a direction along the long side corresponds to an up-down direction and a direction along the short side corresponds to a left-right direction. This usage form is a usage form in which left and right pages when a book is opened correspond to left and right screens, and corresponds to the so-called book mode. This usage form will also be referred to as a “Fold Landscape” because the usage form is the bent form, the first display area DA1 and the second display area DA2 are arranged side by side, and the display area obtained by combining the first display area DA1 and the second display area DA2 is horizontally long.

In this display mode (b), for example, in a normal operation state, the information processing apparatus 10 is in the two-screen display mode in which the first display area DA1 on the left side is used as a primary screen and the second display area DA2 on the right side is used as a secondary screen. In the display mode (b), a correspondence relationship between the first display area DA1 and the second display area DA2, and the primary screen and the secondary screen may be reversed.

As in the display mode (b), a display mode (c-1) is a display mode when the usage form is the bent form, and the two-screen mode is used in which display is controlled such that the screen area of the display 150 is split into two display areas, the first display area DA1 and the second display area DA2, but an orientation of the information processing apparatus 10 is different. The orientation of the information processing apparatus 10 is a portrait orientation such that the first display area DA1 and the second display area DA2 are arranged vertically, up and down in a landscape orientation. The landscape orientation of the display area is an orientation in which a long side of four sides of a rectangular display area is in a horizontal direction and a short side is in a vertical direction. In a case in which the display area is in the landscape orientation, a display orientation is also the landscape orientation, and display is performed in an orientation in which a direction along the short side corresponds to an up-down direction and a direction along the long side corresponds to a left-right direction. This usage form is one of general usage forms of a clamshell PC.

In this display mode (c-1), for example, in a normal operation state, the information processing apparatus 10 is in the two-screen display mode in which the first display area DA1 is used as a primary screen and the second display area DA2 is used as a secondary screen. In the display mode (c-1), a correspondence relationship between the first display area DA1 and the second display area DA2, and the primary screen and the secondary screen may be reversed.

For example, the information processing apparatus 10 detects a change in the posture (orientation) of the information processing apparatus 10, and thus automatically performs switching from the display mode (b) to the display mode (c-1) or from the display mode (c-1) to the display mode (b) (Switch by Rotation). For example, since the display mode (c-1) is a state in which the display 150 is rotated 90 degrees rightward with respect to the display mode (b) as illustrated, when the rightward rotation from a state of the display mode (b) by a predetermined angle (for example, 45 degrees) or more is detected, the information processing apparatus 10 performs the switching to the display mode (c-1). Since the display mode (b) is a state in which the display 150 is rotated 90 degrees leftward with respect to the display mode (c-1) as illustrated, when the leftward rotation from a state of the display mode (c-1) by a predetermined angle (for example, 45 degrees) or more is detected, the information processing apparatus 10 performs the switching to the display mode (b).

As in the display mode (c-1), in a display mode (c-2), the bent form is used and the orientation of the information processing apparatus 10 is the same, but there is a difference in that an external keyboard 30 (Dockable mini Keyboard (KBD)) that can be connected to the information processing apparatus 10 is connected. This usage form is a state in which the physical keyboard 30 is connected in a general usage form of a clamshell PC. For example, the keyboard 30 has almost the same size as the second display area DA2, and can be placed on the second display area DA2. As an example, the keyboard 30 is provided with a magnet in an inner portion (end portion) of a bottom surface, and when the keyboard 30 is placed on the second display area DA2, the keyboard 30 is attracted and fixed to a metal portion of an end portion on the inner surface of the second chassis 102. As a result, the usage form is the same as the usage form of a conventional clamshell PC that is originally provided with the physical keyboard. In addition, the information processing apparatus 10 and the keyboard 30 are connected by, for example, Bluetooth (registered trademark). In this display mode (c-2), the information processing apparatus 10 controls the second display area DA2 to be displayed black or turned off because the second display area DA2 cannot be visually recognized due to the keyboard. In other words, this display mode (c-2) is a display mode (hereinafter, referred to as a “half-screen mode”) in which only half screen is valid for display, and is the one-screen mode using only the first display area DA1.

For example, when the information processing apparatus 10 detects the connection with the external keyboard in a state of the display mode (c-1), the information processing apparatus 10 automatically performs the switching from the display mode (c-1) to the display mode (c-2) (Switch by Dock).

As in the display mode (b), in a display mode (d), the bent form is used and the orientation of the information processing apparatus 10 is the same, but there is a difference in that the display mode (d) is the one-screen mode in which display is controlled such that the entire screen area of the display 150 is used as one display area DA. This usage form is different from the display mode (b) in that the one-screen mode is used, but will also be referred to as the “Fold Landscape” because the bent form is used and the display area DA is horizontally long. The display area DA is in the landscape orientation, and the display orientation is also the landscape orientation.

Here, switching between the one-screen mode and the two-screen mode in the bent form can be performed, for example, by the user's operation. For example, the information processing apparatus 10 displays an operating element as a user interface (UI) that allows switching between the one-screen mode and the two-screen mode at any place on the screen, and performs the switching from the display mode (b) to the display mode (d) based on an operation on the operating element (switch by UI).

As in the display mode (c-1), in a display mode (e), the bent form is used and the orientation of the information processing apparatus 10 is the same, but there is a difference in that the display mode (e) is the one-screen mode in which display is controlled such that the entire screen area of the display 150 is used as one display area DA. This usage form is different from the display mode (c-1) in that the one-screen mode is used, but corresponds to the usage form of the clamshell PC in terms of the bent form and the orientation of the information processing apparatus 10. The display area DA is in the portrait orientation, and the display orientation is also the portrait orientation.

For example, the information processing apparatus 10 detects a change in the posture (orientation) of the information processing apparatus 10, and thus automatically performs switching from the display mode (d) to the display mode (e) or from the display mode (e) to the display mode (d) (Switch by Rotation). For example, since the display mode (e) is a state in which the display 150 is rotated 90 degrees rightward with respect to the display mode (d) as illustrated, when the rightward rotation from a state of the display mode (d) by a predetermined angle (for example, 45 degrees) or more is detected, the information processing apparatus 10 performs the switching to the display mode (e). Since the display mode (d) is a state in which the display 150 is rotated 90 degrees leftward with respect to the display mode (e) as illustrated, when the leftward rotation from a state of the display mode (e) by a predetermined angle (for example, 45 degrees) or more is detected, the information processing apparatus 10 performs the switching to the display mode (d).

As in the display mode (d), in a display mode (d′), the one-screen mode is used and the orientation of the information processing apparatus 10 is an orientation in which the display area DA is horizontally long, but there is a difference in that the flat form is used. The flat form is a state in which the opening angle θ between the first chassis 101 and the second chassis 102 is about 180°. This usage form corresponds to the so-called tablet mode described with reference to FIG. 3, and will also be referred to as the “Flat Landscape” because the flat form is used and the display area DA is horizontally long. This display mode (d′) is different from the display mode (d) only in terms of the opening angle θ between the first chassis 101 and the second chassis 102. As in the display mode (d), the display area DA is in the landscape orientation, and the display orientation is also the landscape orientation.

As in the display mode (e), in a display mode (e′), the one-screen mode is used and the orientation of the information processing apparatus 10 is an orientation in which the display area DA is vertically long, but there is a difference in that the flat form is used. This usage form will also be referred to as a “Flat Portrait” because the flat form is used and the display area DA is vertically long. This display mode (e′) is different from the display mode (e) only in terms of the opening angle θ between the first chassis 101 and the second chassis 102. As in the display mode (e), the display area DA is in the portrait orientation, and the display orientation is also the portrait orientation.

For example, the information processing apparatus 10 detects a change in the posture (orientation) of the information processing apparatus 10, and thus automatically performs switching from the display mode (d′) to the display mode (e′) or from the display mode (e′) to the display mode (d′) (Switch by Rotation). For example, since the display mode (e′) is a state in which the display 150 is rotated 90 degrees rightward with respect to the display mode (d′) as illustrated, when the rightward rotation from a state of the display mode (d′) by a predetermined angle (for example, 45 degrees) or more is detected, the information processing apparatus 10 performs the switching to the display mode (e′). Since the display mode (d′) is a state in which the display 150 is rotated 90 degrees leftward with respect to the display mode (e′) as illustrated, when the leftward rotation from a state of the display mode (e′) by a predetermined angle (for example, 45 degrees) or more is detected, the information processing apparatus 10 performs the switching to the display mode (d′).

Here, switching between the one-screen mode and the two-screen mode in the flat form can be performed, for example, by the user's operation. For example, as described above, in the display mode (d′) and the display mode (e′), the information processing apparatus 10 displays the operating element as a UI that allows switching between the one-screen mode and the two-screen mode at any place on the screen, and by the user operating this operating element, it is also possible to switch to the two-screen mode while remaining in the flat form. For example, when the switching from a state of the display mode (d′) to the two-screen mode is performed, the display state is the same as the display state of the display mode (b) in the flat form. When the switching from a state of the display mode (e′) to the two-screen mode is performed, the display state is the same as the display state of the display mode (c-1) in the flat form.

When the information processing apparatus 10 detects the connection with the keyboard 30 in a state of the display mode (e′), the information processing apparatus 10 automatically performs the switching from the display mode (e′) to the display mode (c-2′) (Switch by Dock). The display mode (c-2′) is the flat form, and is different from the display mode (c-2) only in terms of the opening angle θ between the first chassis 101 and the second chassis 102. In this display mode (c-2′), the information processing apparatus 10 controls the second display area DA2 to be displayed black or turned off because the second display area DA2 cannot be visually recognized due to the keyboard. In other words, as in the display mode (c-2), this display mode (c-2′) is the half-screen mode in which only one half screen is valid for display.

Further, the information processing apparatus 10 can also automatically switch from the one-screen mode to the two-screen mode by detecting a change from a flat form to a bent form (switch by hinge angle). For example, in a case in which the change to the bent form in a state of the display mode (d′) is detected based on the opening angle θ between the first chassis 101 and the second chassis 102, the information processing apparatus 10 automatically performs the switching from the display mode (d′) to the display mode (b). In a case in which the change to the bent form in a state of the display mode (e′) is detected based on the opening angle θ between the first chassis 101 and the second chassis 102, the information processing apparatus 10 automatically performs the switching from the display mode (e′) to the display mode (c-1).

Here, when switched to the one-screen mode by the display mode switching function as described with reference to FIG. 4, the information processing apparatus 10 arranges the window arranged in the screen area of the display 150 by using the screen area as one display area. On the other hand, when switched to the two-screen mode, the information processing apparatus 10 can arrange the window arranged in the screen area of the display 150 by using a display area in which the screen area is split into two.

For example, when switched from the one-screen mode to the two-screen mode, the information processing apparatus 10 displays the active window of the running app in one-screen mode in the first display area DA1. For example, the information processing apparatus 10 maximizes the active window displayed in the display area DA in the one-screen mode to the entire display area of the first display area DA1 to display the active window as an active window when the display mode transitions to the two-screen mode. In addition, the information processing apparatus 10 arranges a window that was an inactive window in the one-screen mode on a layer behind the foremost layer on which the active window is displayed in the first display area DA1 in a state in which the layer relationship (the overlapping order of the windows) in the one-screen mode is maintained, when the display mode transitions to the two-screen mode. Therefore, in the first display area DA1, the active window is maximized and displayed, and the inactive window is not displayed (not visible to the user), although the inactive window exists on a layer behind the active window.

In addition, when switched from the one-screen mode to the two-screen mode, the information processing apparatus 10 generates thumbnail images of windows that were inactive windows in one-screen mode and displays the thumbnail images in the second display area DA2 (secondary screen). When there are a plurality of inactive windows, the information processing apparatus 10 displays the thumbnail images of the plurality of inactive windows in the second display area DA2.

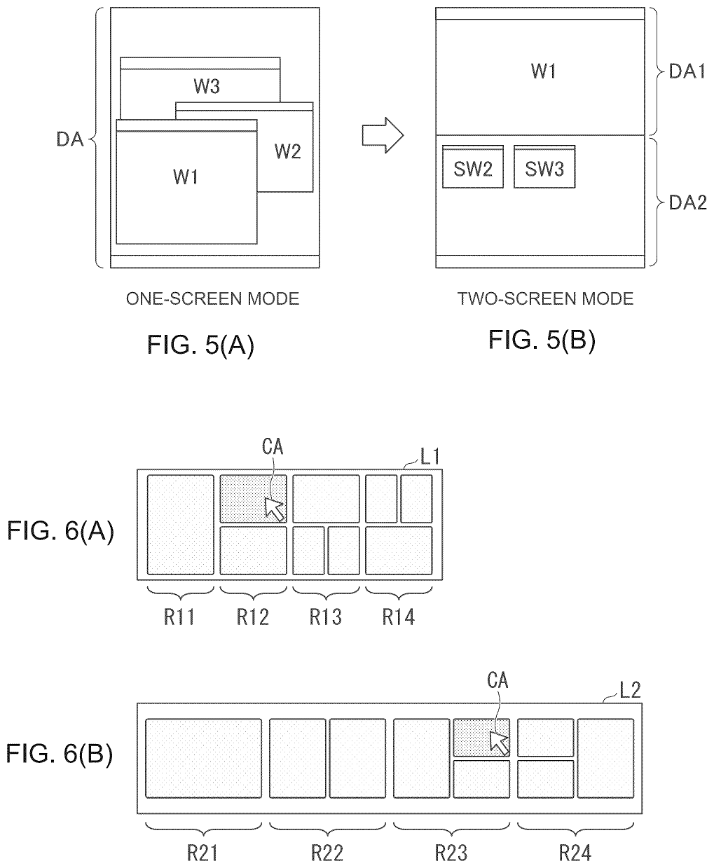

FIG. 5 is a view illustrating an example of display control when switching from the one-screen mode to the two-screen mode according to the present embodiment. FIG. 5(A) illustrates a display example in the one-screen mode, and FIG. 5(B) illustrates a display example after switching to the two-screen mode. In the example illustrated in the figure, the number of windows of the running app in the one-screen mode is three. Here, three windows W1, W2, and W3 are illustrated in the display area DA. The window W1 is an active window that is arranged on the foremost layer (topmost layer). When switching from the one-screen mode to the two-screen mode, the window W1 is maximized and rearranged in the first display area DA1 and displayed as an active window.

In addition, the windows W2 and W3 are rearranged on the lower layer of the window W1 while maintaining the vertical relationship of the layers, and thumbnail images SW2 and SW3 of the windows W2 and W3 are displayed in the second display area DA2. When the number of windows of the running app in the one-screen mode is four or more, the number of thumbnail images displayed in the second display area DA2 when switched to the two-screen mode is also three or more.

When the user selects any of the thumbnail images that may be displayed in the second display area DA2, the information processing apparatus 10 maximizes and rearranges the window corresponding to the selected thumbnail image in the second display area DA2, for example, to display the window as an active window. At this time, the window W1 that is arranged in the first display area DA1 continues to be arranged as an inactive window. At this time, in the first display area DA1, the thumbnail images of windows other than the window rearranged in the second display area DA2, may be displayed.

In addition, apart from the display mode switching function described above, the information processing apparatus 10 has a function of arranging windows of an application in a desired display area within a screen area (so-called snap function). This snap function allows the user to switch (select) which of the selected windows arranged in the screen area of the display 150 will be arranged in any of predetermined layouts within the screen area.

For example, the information processing apparatus 10 displays an operating element as a user interface (UI) from which a display area within the screen area of the display 150 can be selected, in which a window is to be arranged (laid out), and displays the window in a display area selected by the user based on the user's operation on the operating element. The UI from which the display area in which this window is to be arranged can be selected will be referred to as a “layout selection icon” below.

The layout of the display area that can be selected by operating this layout selection icon is the layout for the entire screen area (display area DA) of the display 150, regardless of whether the display mode described with reference to FIG. 4 is the one-screen mode or the two-screen mode. In addition, in the half-screen mode, since half of the screen area of the display 150 (first display area DA1) is an effective screen area, the layout is for the first display area DA1.

### [Example of Layout Selection Icons]

Next, a specific example of the layout selection icons will be described.

FIG. 6 is a view illustrating a display example of layout selection icons according to the present embodiment. FIG. 6(A) illustrates an example of a layout selection icon L1 displayed when the usage form is “Portrait (or Clamshell)” (display mode (c-1), display mode (e), display mode (e′), and the like).

In the layout selection icon L1, the portion indicated by a reference numeral R11 is a layout in which the entire screen area of the display 150 is one display area, and the entire screen area can be selected as the display area in which a window is to be arranged. The portion indicated by a reference numeral R12 is a layout in which the screen area is split into two, upper and lower, and the upper display area or the lower display area within the screen area can be selected as the display area in which a window is to be arranged. In addition, the portion indicated by a reference numeral R13 and the portion indicated by a reference numeral R14 are layouts in which the screen area is split into three. The portion indicated by the reference numeral R13 is a layout in which the lower display area, which is obtained by splitting the screen area into two, upper and lower, is further split into two, left and right. The portion indicated by the reference numeral R14 is a layout in which the upper display area, which is obtained by splitting the screen area into two, upper and lower, is further split into two, left and right. In the portion indicated by the reference numeral R13 and the portion indicated by the reference numeral R14, any one of three display areas can be selected as a display area in which a window is to be arranged.

For example, when the usage form is “Portrait (or Clamshell)”, the layout selection icon L1 is displayed when the user drags a window. As shown in the figure, when a cursor CA, which is being dragged, is hovered over the upper area of the layout obtained by splitting the screen area into two, indicated by the reference numeral R12, the display area corresponding to the upper area is selected. The display mode (color, brightness, or the like) of the selected area within the layout selection icon L1 is changed. When the drag operation is completed, a window is displayed in the selected upper display area.

FIG. 6(B) illustrates an example of the layout selection icon L2 displayed when the usage form is “Landscape” (display mode (b), display mode (d), display mode (d′), and the like).

In the layout selection icon L2, the portion indicated by the reference numeral R21 is a layout in which the entire screen area of the display 150 is one display area, and the entire screen area can be selected as the display area in which a window is to be arranged. The portion indicated by a reference numeral R22 is a layout in which the screen area is split into two, left and right, and the left display area or the right display area within the screen area can be selected as the display area in which a window is to be arranged. In addition, the portion indicated by a reference numeral R23 and the portion indicated by a reference numeral R24 are layouts in which the screen area is split into three. The portion indicated by the reference numeral R23 is a layout in which the right display area, which is obtained by splitting the screen area into two, left and right, is further split into two, upper and lower. The portion indicated by the reference numeral R24 is a layout in which the left display area, which is obtained by splitting the screen area into two, left and right, is further split into two, upper and lower. In the portion indicated by the reference numeral R23 and the portion indicated by the reference numeral R24, any one of three display areas can be selected as a display area in which a window is to be arranged.

For example, when the usage form is “Landscape”, the layout selection icon L2 is displayed by the user dragging a window. As shown in the figure, when the cursor CA that is being dragged is hovered over the upper area on the right side of the layout in which the screen area indicated by the reference numeral R23 is split into three, the display area corresponding to the upper area on the right side is selected. The display mode (color, brightness, or the like) of the selected area within the layout selection icon L2 is changed. When the drag operation is completed, a window is displayed in the selected upper display area on the right side.

[Configuration of Connection with External Display]

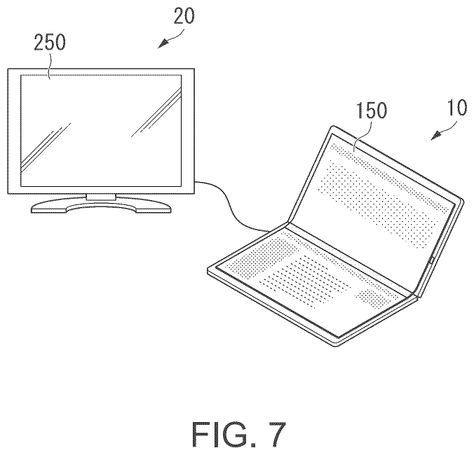

In addition, the information processing apparatus 10 can also be used by being connected to an external display. FIG. 7 is a view illustrating an example of a configuration in which the information processing apparatus 10 according to the present embodiment is connected to an external display. The information processing apparatus 10 is connected to an external display device 20 (display device). Any connection method using HDMI (registered trademark), USB Type-C, display port, or the like can be applied as a connection method. The information processing apparatus 10 may be wirelessly connected to the external display device 20. The external display device 20 is configured to include a display 250 as an external display. In contrast to an external display, the display 150 of the information processing apparatus 10 is an embedded display.

When connecting to the external display device 20 and controlling display in a plurality of screen areas (a plurality of screen areas that do not overlap with each other) between the screen area of the embedded display and the screen area of the external display, the information processing apparatus 10 can display a window on both the screen area of the embedded display and the screen area of the external display by using the layout selection icons described with reference to FIG. 6.

For example, the information processing apparatus 10 can display a window displayed in the screen area of the embedded display in any of the display areas in each layout within the screen area of the embedded display, or can display the window in any of the display areas in each layout of the external display. Similarly, the information processing apparatus 10 can display a window displayed on the screen area of the external display in any of the display areas in each layout of the external display, or in any of the display areas in each layout within the screen area of the embedded display.

When connected to the external display device 20, the information processing apparatus 10 displays a UI as an operating element for selecting which of the embedded display and the external display is to be the screen area for displaying a window before displaying the layout selection icons illustrated in FIG. 6. This UI will be referred to as a “display selection icon” below.

### [Example of Display Selection Icons]

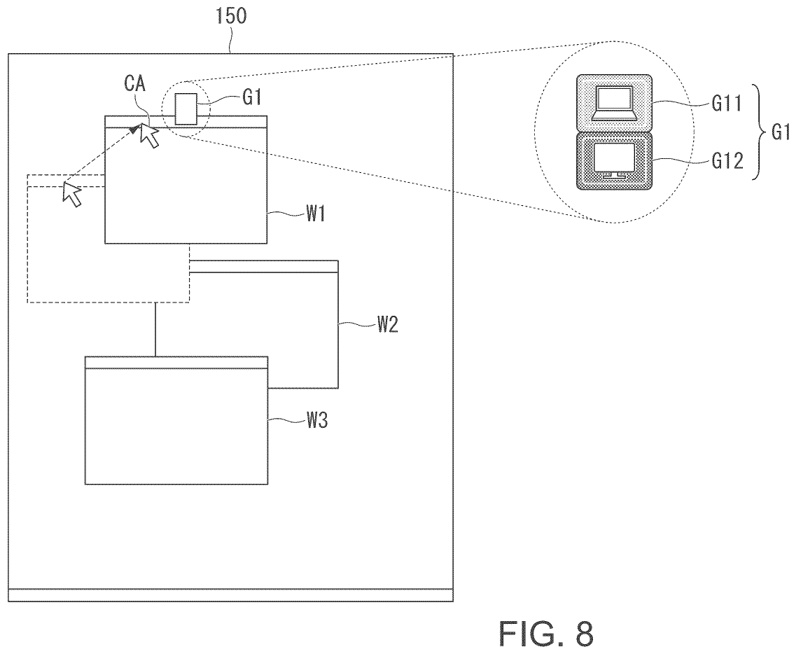

FIG. 8 is a view illustrating a display example of display selection icons according to the present embodiment. When a drag operation is started on the window W1 displayed on the embedded display (display 150) or external display (display 250), display selection icons G1 are displayed near the position of the cursor CA to be dragged. This figure illustrates an example when a drag operation is started on the window W1 displayed on the embedded display (display 150). The display position of this display selection icons G1 remains unchanged even if the cursor CA is moved by a drag operation.

The display selection icons G1 include an embedded display icon G11 corresponding to the screen area of the embedded display, and an external display icon G12 corresponding to the screen area of the external display. The embedded display icon G11 and the external display icon G12 are displayed with different designs (figures, pictures) imitating the types of the respective displays. That is, the embedded display icon G11 has a design imitating the embedded display provided in the information processing apparatus 10 (for example, a notebook PC). On the other hand, the external display icon G12 has a design imitating the shape of the external display device 20. As a result, when selecting a display for displaying (screen area) by using the display selection icons G1, it is intuitive to know which icon is the selection for the embedded display and which icon is the selection for the external display, and the operability is good.

In addition, when connected to an external display, the display selection icons G1 include both the embedded display icon G11 and the external display icon G12, but when not connected to an external display, only the embedded display icon G11 is displayed. Even when not connected to an external display, the embedded display icon G11 is displayed as an operating element for selecting whether or not to use the embedded display as a screen area for displaying a window.

In FIG. 8, the window W2 and the window W3, which are arranged (displayed) in the screen area of the embedded display (display 150), are illustrated as examples of windows other than the window W1 being dragged. Here, the window W2 and the window W3 are inactive windows since the window W1 is an active window being dragged.

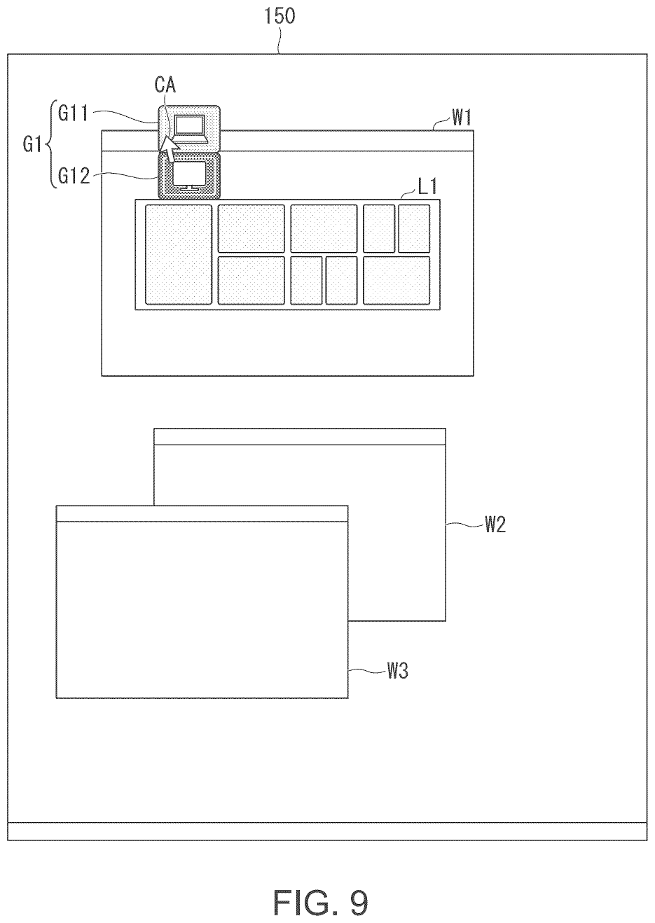

FIG. 9 is a view illustrating a selection example of the display selection icon according to the present embodiment. By hovering the cursor CA that is being dragged over either the embedded display icon G11 or the external display icon G12 of the display selection icons G1, it is possible to select the screen area of the embedded display or the screen area of the external display. FIG. 9 illustrates a display example when an embedded display is selected with the display selection icon.

As illustrated in the figure, when the cursor CA being dragged on the window W1 is hovered over the embedded display icon G11 while being dragged, the embedded display is selected. In addition, when the screen area of the embedded display is selected, a layout selection icon is displayed, from which a display area in each layout within the screen area of the embedded display can be selected. The layout selection icon L1 or the layout selection icon L2 is displayed depending on whether the usage form at that time is “Portrait (or Clamshell)” or “Landscape”. Here, the layout selection icon L1 displayed when “Portrait (or Clamshell)” is selected is illustrated as an example.

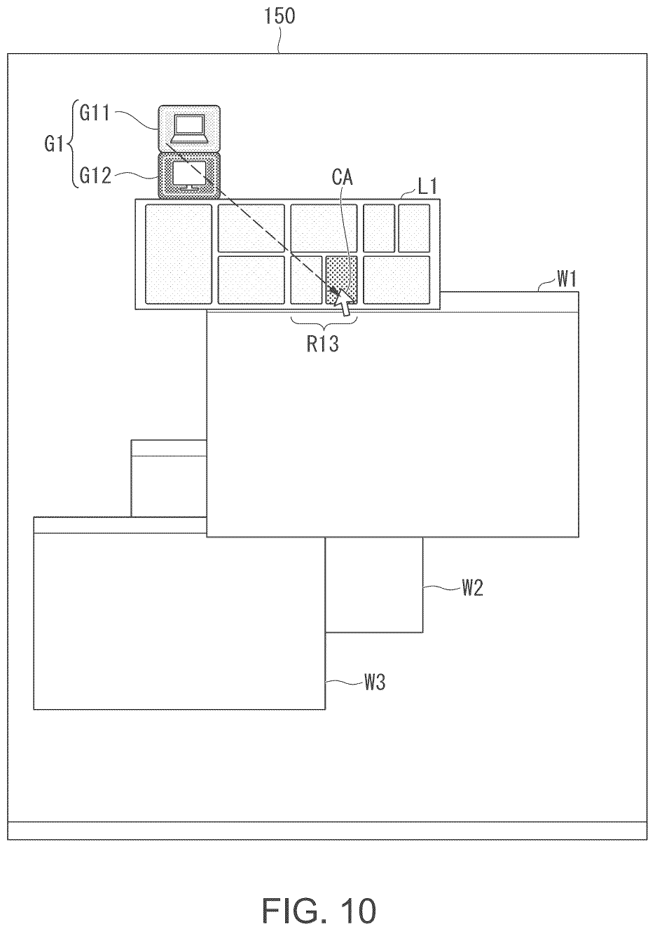

FIG. 10 is a view illustrating a display example when a layout (display area) is selected by using the layout selection icons according to the present embodiment. As illustrated in the figure, when the cursor CA that has been hovered over the embedded display icon G11 by dragging the window W1 is hovered over any area in the layout selection icon L1 by continuing the drag operation, the display area hovered by the cursor CA can be selected.

In the example illustrated in the figure, by hovering the cursor CA being dragged over the upper area of the three areas indicated by the reference numeral R13 on the layout selection icon L1, the upper area is selected.

Here, when the drag operation is completed with the cursor CA being dragged hovered over any area in the layout selection icon L1 or L2, the display selection and layout (display area) selection are confirmed, and the display position of the window W1 being dragged is changed to the display area within the screen area of the selected display.

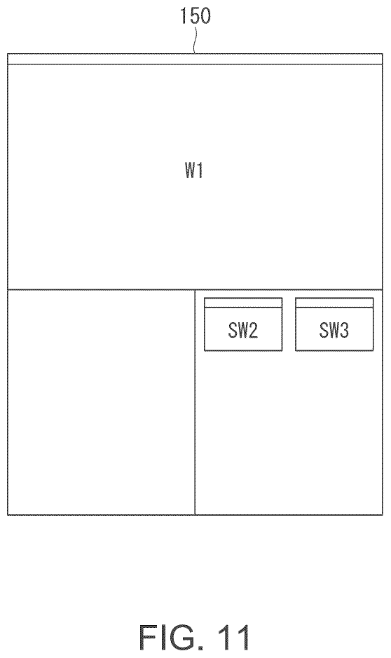

FIG. 11 is a view illustrating a display example when a display position of a window is changed in response to completion of a drag operation according to the present embodiment. For example, as illustrated in FIG. 10, in a state in which an embedded display is selected and the cursor CA being dragged is hovered over the upper display area of the three display areas indicated by the reference numeral R13 on the layout selection icon L1, when the drag operation is completed, the window W1 that is being dragged is arranged (snapped) to the display area in the embedded display (display 150) corresponding to the upper display area.

In addition, the thumbnail images of the window W2 and the window W3 other than window W1 being dragged are arranged to be displayed in the display area other than the display area in which the window W1 is arranged. For example, as illustrated in FIG. 11, when the window W1 is arranged in the upper display area in the embedded display (display 150), the thumbnail images of the window W2 and the window W3 are arranged in the lower right display area.

Here, the information processing apparatus 10 determines a display area in which the thumbnail images of other windows are to be arranged with respect to the display area in which the window is arranged by the snap function, according to a predetermined arrangement rule in a certain arrangement order. For example, the information processing apparatus 10 determines a display area in which the thumbnail images are to be arranged, always in a clockwise direction, starting from the display area of the window that has been snapped (arranged).

As a layout that can be selected by the layout selection icons L1 and L2 illustrated in FIG. 6, for a layout in which the screen area is split into two display areas and a layout in which the screen area is split into three display areas, an example of an arrangement rule for determining a display area in which thumbnail images are to be arranged will be described below. Since this rule of arranging the thumbnail images is the same for both embedded and external displays, and is therefore described below without any distinction.

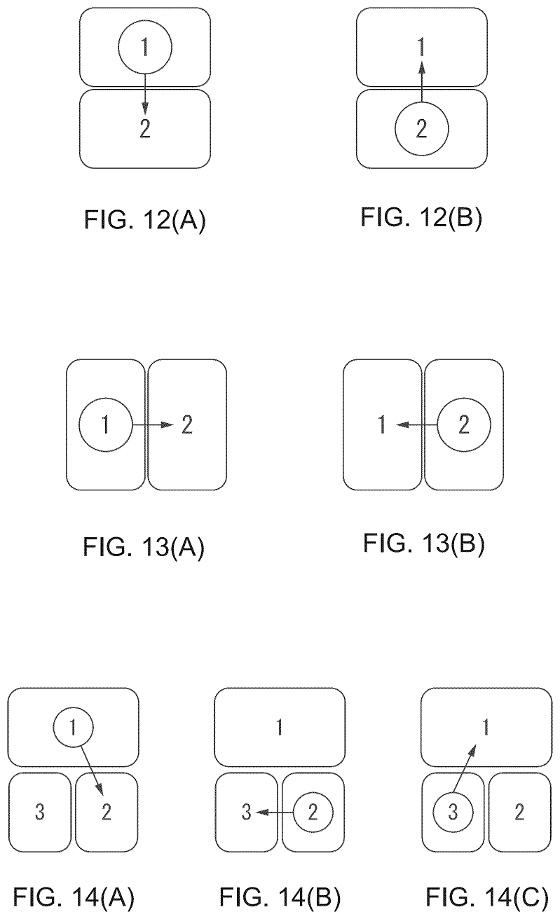

FIG. 12 is a view illustrating a first example of a rule for arranging the thumbnail images according to the present embodiment. FIG. 12 illustrates an example of a rule for arranging the thumbnail images in a layout in which the screen area of a display is vertically split into two display areas, a first display area (referred to as “1”) and a second display area (referred to as “2”). The display areas surrounded by a circle in “1” and “2” indicate the display areas in which a window is arranged by the snap function. In addition, starting from the display area in which a window is arranged by the snap function, the display area at the tip of an arrow indicates the display area in which the thumbnail images are to be arranged.

In the layout selection icon L1 illustrated in FIG. 6, when the upper area of the layout indicated by the reference numeral R12 is selected by a drag operation on a window, as illustrated in FIG. 12(A), the information processing apparatus 10 arranges the window in the upper first display area and arranges the thumbnail images of other windows in the lower second display area. At this time, even if there is already a window arranged in the lower second display area, the thumbnail images are preferentially arranged. For example, by arranging the thumbnail images on an upper layer than the arranged window, overwriting the thumbnail images on the arranged window, or replacing the thumbnail images with the arranged window, the thumbnail images are preferentially arranged.

In addition, in the layout selection icon L1 illustrated in FIG. 6, when the lower area of the layout indicated by the reference numeral R12 is selected by a drag operation on a window, as illustrated in FIG. 12(B), the information processing apparatus 10 arranges the window in the lower second display area and arranges the thumbnail images of other windows in the upper first display area. At this time, even if there is already a window arranged in the upper first display area, the thumbnail images are preferentially arranged.

In addition, when any of the thumbnail images arranged in the lower second display area illustrated in FIG. 12(A) is selected, the information processing apparatus 10 arranges the window corresponding to the selected thumbnail image in the lower second display area. At this time, the window that is already arranged continues to be arranged in the upper first display area. In addition, when any of the thumbnail images arranged in the upper first display area illustrated in FIG. 12(B) is selected, the information processing apparatus 10 arranges the window corresponding to the selected thumbnail image in the upper first display area. At this time, the window that is already arranged continues to be arranged in the lower second display area.

When any of the thumbnail images arranged in the lower second display area illustrated in FIG. 12(A) is selected, the information processing apparatus 10 may arrange the window corresponding to the selected thumbnail image in the lower second display area and may preferentially arrange the thumbnail images of the other windows in the upper first display area. At this time, a window is already arranged in the first display area before any of the thumbnail images is selected, but the thumbnail images are preferentially arranged. In addition, similarly, when any of the thumbnail images arranged in the upper first display area illustrated in FIG. 12(B) is selected, the information processing apparatus 10 may arrange the window corresponding to the selected thumbnail image in the upper first display area and may preferentially arrange the thumbnail images of the other windows in the lower second display area.

In a state in which the thumbnail images are displayed, when an operation (for example, touch operation) is performed to select an area other than the thumbnail images, at that point, the thumbnail display (display of thumbnail images) ends. For example, if the user touches the window displayed in the upper first display area in the example illustrated in FIG. 12(A) to start work, the display of the thumbnail images displayed in the lower second display area ends. Similarly, for example, if the user touches the window displayed in the lower second display area in the example illustrated in FIG. 12(B) to start work, the display of the thumbnail images displayed in the upper first display area ends. In addition, similarly, when a touch operation is performed on an area other than the thumbnail images within the display area in which the thumbnail images are displayed, the thumbnail display ends.

FIG. 13 is a view illustrating a second example of the rule for arranging the thumbnail images according to the present embodiment. FIG. 13 illustrates an example of the rule of arranging the thumbnail images in a layout in which the screen area of the display is horizontally split into two display areas, a first display area (referred to as “1”) and a second display area (referred to as “2”). Similarly to FIG. 12, the display areas surrounded by a circle in “1” and “2” indicate the display areas in which a window is arranged by the snap function. In addition, starting from the display area in which a window is arranged by the snap function, the display area at the tip of an arrow indicates the display area in which the thumbnail images are to be arranged.

In the layout selection icon L2 illustrated in FIG. 6, when the left area of the layout indicated by the reference numeral R22 is selected by a drag operation on a window, as illustrated in FIG. 13(A), the information processing apparatus 10 arranges the window in the left first display area and arranges the thumbnail images of other windows in the right second display area. At this time, even if there is already a window arranged in the right second display area, the thumbnail images are preferentially arranged.

In addition, in the layout selection icon L2 illustrated in FIG. 6, when the right area of the layout indicated by the reference numeral R22 is selected by a drag operation on a window, as illustrated in FIG. 13(B), the information processing apparatus 10 arranges the window in the right second display area and arranges the thumbnail images of other windows in the left first display area. At this time, even if there is already a window arranged in the left first display area, the thumbnail images are preferentially arranged.

In addition, when any of the thumbnail images arranged in the right second display area illustrated in FIG. 13(A) is selected, the information processing apparatus 10 arranges the window corresponding to the selected thumbnail image in the right second display area. At this time, the window that is already arranged continues to be arranged in the left first display area. In addition, when any of the thumbnail images arranged in the left first display area illustrated in FIG. 13(B) is selected, the information processing apparatus 10 arranges the window corresponding to the selected thumbnail image in the left first display area. At this time, the window that is already arranged continues to be arranged in the right second display area.

When any of the thumbnail images arranged in the right second display area illustrated in FIG. 13(A) is selected, as illustrated in FIG. 13(B), the information processing apparatus 10 may arrange the window corresponding to the selected thumbnail image in the right second display area and may preferentially arrange the thumbnail images of the other windows in the left first display area. At this time, before a thumbnail image is selected, a window is already arranged in the first display area, but the thumbnail image is preferentially arranged (for example, arranged on the upper layer). In addition, similarly, when any of the thumbnail images arranged in the left first display area illustrated in FIG. 13(B) is selected, the information processing apparatus 10 may arrange the window corresponding to the selected thumbnail image in the left first display area and may preferentially arrange the thumbnail images of the other windows in the right second display area.

In a state in which the thumbnail images are displayed, when an operation (for example, touch operation) is performed to select an area other than the thumbnail images, at that point, the thumbnail display ends.

FIG. 14 is a view illustrating a third example of the rule for arranging the thumbnail images according to the present embodiment. FIG. 14 illustrates an example of the rule for arranging the thumbnail images in a layout in which the screen area of the display is split into three display areas by splitting the screen area into two upper and lower display areas and further splitting the split lower display area into two left and right display areas. This layout corresponds to the layout indicated by the reference numeral R13 of the layout selection icon L1 illustrated in FIG. 6.

Here, the upper display area is referred to as a first display area (referred to as “1”), the lower right display area is referred to as a second display area (referred to as “2”), and the lower left display area is referred to as a third display area (referred to as “3”). In addition, a display area surrounded by a circle among “1”, “2”, and “3” indicates a display area in which a window is arranged by the snap function. In addition, starting from the display area in which a window is arranged by the snap function, the display area at the tip of an arrow indicates the display area in which the thumbnail images are to be arranged.

In the layout selection icon L1 illustrated in FIG. 6, when the upper area of the layout indicated by the reference numeral R13 is selected by a drag operation on a window, as illustrated in FIG. 14(A), the information processing apparatus 10 arranges the window in the upper first display area and arranges the thumbnail images of other windows in the lower right second display area. At this time, even if there is already a window arranged in the lower right second display area, the thumbnail images are preferentially arranged.

In addition, in the layout selection icon L1 illustrated in FIG. 6, when the lower right area of the layout indicated by the reference numeral R13 is selected by a drag operation on a window, as illustrated in FIG. 14(B), the information processing apparatus 10 arranges the window in the lower right second display area and arranges the thumbnail images of other windows in the lower left third display area. At this time, even if there is already a window arranged in the lower left third display area, the thumbnail images are preferentially arranged.

In addition, in the layout selection icon L1 illustrated in FIG. 6, when the lower left area of the layout indicated by the reference numeral R13 is selected by a drag operation on a window, as illustrated in FIG. 14(C), the information processing apparatus 10 arranges the window in the lower left third display area and arranges the thumbnail images of other windows in the upper first display area. At this time, even if there is already a window arranged in the upper first display area, the thumbnail images are preferentially arranged.

In addition, when any of the thumbnail images arranged in the lower right second display area illustrated in FIG. 14(A) is selected, similarly to the example illustrated in FIG. 14(B), the information processing apparatus 10 arranges the window corresponding to the selected thumbnail image in the lower right second display area and arranges the thumbnail images of the other windows in the lower left third display area. Even if a window is already arranged in the display area in which the thumbnail images are to be arranged, the thumbnail images are preferentially arranged (for example, arranged on the upper layer). Subsequently, when any of the thumbnail images arranged in the lower left third display area is selected, the information processing apparatus 10 arranges the window corresponding to the selected thumbnail image in the lower left third display area. At this time, the thumbnail images are not arranged in the upper first display area, and the window that is already arranged in both the first display area and the second display area continues to be arranged.

As described above, if a thumbnail image is selected in the second display area of FIG. 14(A), a window is displayed in the second display area and the thumbnail image is displayed in the third display area, but if a thumbnail image is subsequently selected in the third display area, a window is displayed in the third display area but no thumbnail image is displayed. That is, the thumbnail display ends at a time point (that is, the end of a first round) at which a window is displayed in the order of the first display area, the second display area, and the third display area and one round is completed. In addition, when a thumbnail image is selected in the third display area in FIG. 14(B), a window is displayed in the third display area and the thumbnail image is displayed in the first display area, but when a thumbnail image is subsequently selected in the first display area, a window is displayed in the first display area but no thumbnail image is displayed. That is, the thumbnail display ends at a time point (that is, the end of a first round) at which a window is displayed in the order of the second display area, the third display area, and the first display area and one round is completed. In addition, when a thumbnail image is selected in the first display area in FIG. 14(C), a window is displayed in the first display area and the thumbnail image is displayed in the second display area, but when a thumbnail image is subsequently selected in the second display area, a window is displayed in the second display area but no thumbnail image is displayed. That is, the thumbnail display ends at a time point (that is, the end of a first round) at which a window is displayed in the order of the third display area, the first display area, and the second display area and one round is completed.

In a state in which the thumbnail images are displayed, when an operation (for example, touch operation) is performed to select an area other than the thumbnail images, at that point, the thumbnail display ends. In addition, the thumbnail display does not have to end at the end of the first round, and the thumbnail images may continue to be arranged in the display area determined according to a certain arrangement rule (in a certain arrangement order).

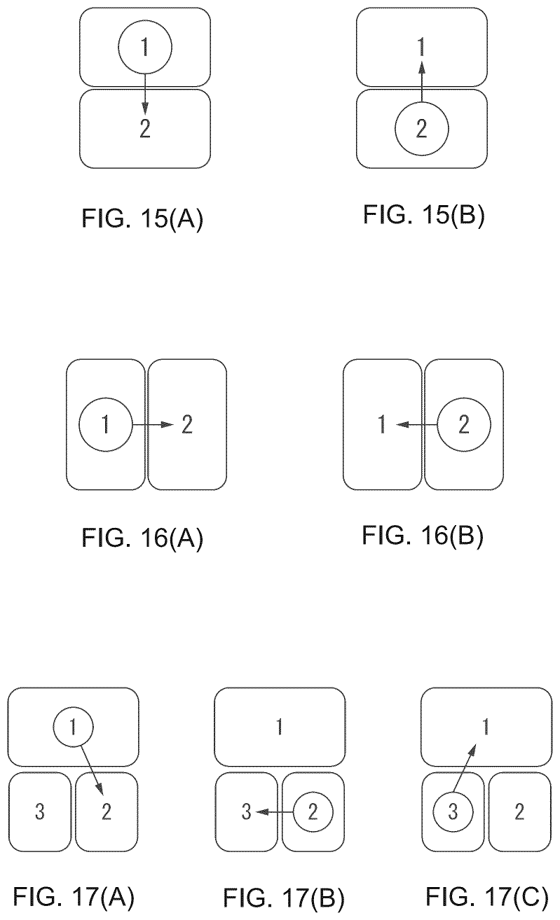

FIG. 15 is a view illustrating a fourth example of the rule for arranging the thumbnail images according to the present embodiment. FIG. 15 illustrates an example of the rule for arranging the thumbnail images in a layout in which the screen area of the display is split into three display areas by splitting the screen area into two upper and lower display areas and further splitting the split upper display area into two left and right display areas. This layout corresponds to the layout indicated by the reference numeral R14 of the layout selection icon L1 illustrated in FIG. 6.

Here, the upper left display area is referred to as a first display area (referred to as “1”), the upper right display area is referred to as a second display area (referred to as “2”), and the lower display area is referred to as a third display area (referred to as “3”). In addition, a display area surrounded by a circle among “1”, “2”, and “3” indicates a display area in which a window is arranged by the snap function. In addition, starting from the display area in which a window is arranged by the snap function, the display area at the tip of an arrow indicates the display area in which the thumbnail images are arranged.

In the layout selection icon L1 illustrated in FIG. 6, when the upper left area of the layout indicated by the reference numeral R14 is selected by a drag operation on a window, as illustrated in FIG. 15(A), the information processing apparatus 10 arranges the window in the upper left first display area and arranges the thumbnail images of other windows in the upper right second display area. At this time, even if there is already a window arranged in the upper right second display area, the thumbnail images are preferentially arranged.

In addition, in the layout selection icon L1 illustrated in FIG. 6, when the upper right area of the layout indicated by the reference numeral R14 is selected by a drag operation on a window, as illustrated in FIG. 15(B), the information processing apparatus 10 arranges the window in the upper right second display area and arranges the thumbnail images of other windows in the lower third display area. At this time, even if there is already a window arranged in the lower third display area, the thumbnail images are preferentially arranged.

In addition, in the layout selection icon L1 illustrated in FIG. 6, when the lower area of the layout indicated by the reference numeral R14 is selected by a drag operation on a window, as illustrated in FIG. 15(C), the information processing apparatus 10 arranges the window in the lower third display area and arranges the thumbnail images of other windows in the upper left first display area. At this time, even if there is already a window arranged in the upper left first display area, the thumbnail images are preferentially arranged.

In addition, when any of the thumbnail images arranged in the upper right second display area illustrated in FIG. 15(A) is selected, similarly to the example illustrated in FIG. 15(B), the information processing apparatus 10 arranges the window corresponding to the selected thumbnail image in the upper right second display area and arranges the thumbnail images of the other windows in the lower third display area. Even if a window is already arranged in the display area in which the thumbnail images are to be arranged, the thumbnail images are preferentially arranged (for example, arranged on the upper layer). Subsequently, when any of the thumbnail images arranged in the lower third display area is selected, the information processing apparatus 10 arranges the window corresponding to the selected thumbnail image in the lower third display area. At this time, the thumbnail images are not arranged in the upper left first display area, and the window that is already arranged in both the first display area and the second display area continues to be arranged.

As described above, when a thumbnail image is selected in the second display area in FIG. 15(A), a window is displayed in the second display area and the thumbnail image is displayed in the third display area, but when a thumbnail image is subsequently selected in the third display area, a window is displayed in the third display area but no thumbnail image is displayed. That is, the thumbnail display ends at a time point (that is, the end of a first round) at which a window is displayed in the order of the first display area, the second display area, and the third display area and one round is completed. In addition, when a thumbnail image is selected in the third display area in FIG. 15(B), a window is displayed in the third display area and the thumbnail image is displayed in the first display area, but when a thumbnail image is subsequently selected in the first display area, a window is displayed in the first display area but no thumbnail image is displayed. That is, the thumbnail display ends at a time point (that is, the end of a first round) at which a window is displayed in the order of the second display area, the third display area, and the first display area and one round is completed. In addition, when a thumbnail image is selected in the first display area in FIG. 15(C), a window is displayed in the first display area and the thumbnail image is displayed in the second display area, but when a thumbnail image is subsequently selected in the second display area, a window is displayed in the second display area but no thumbnail image is displayed. That is, the thumbnail display ends at a time point (that is, the end of a first round) at which a window is displayed in the order of the third display area, the first display area, and the second display area and one round is completed.

In a state in which the thumbnail images are displayed, when an operation (for example, touch operation) is performed to select an area other than the thumbnail images, at that point, the thumbnail display ends. In addition, the thumbnail display does not have to end at the end of the first round, and the thumbnail images may continue to be arranged in the display area determined according to a certain arrangement rule (in a certain arrangement order).

FIG. 16 is a view illustrating a fifth example of the rule for arranging the thumbnail images according to the present embodiment. FIG. 16 illustrates an example of the rule for arranging the thumbnail images in a layout in which the screen area of the display is split into three display areas by splitting the screen area into two left and right display areas and further splitting the split right display area into two upper and lower display areas. This layout corresponds to the layout indicated by the reference numeral R23 of the layout selection icon L2 illustrated in FIG. 6.

Here, the left display area is referred to as a first display area (referred to as “1”), the right upper display area is referred to as a second display area (referred to as “2”), and the right lower display area is referred to as a third display area (referred to as “3”). In addition, a display area surrounded by a circle among “1”, “2”, and “3” indicates a display area in which a window is arranged by the snap function. In addition, starting from the display area in which a window is arranged by the snap function, the display area at the tip of an arrow indicates the display area in which the thumbnail images are arranged.

In the layout selection icon L2 illustrated in FIG. 6, when the left area of the layout indicated by the reference numeral R23 is selected by a drag operation on a window, as illustrated in FIG. 16(A), the information processing apparatus 10 arranges the window in the left first display area and arranges the thumbnail images of other windows in the right upper second display area. At this time, even if there is already a window arranged in the right upper second display area, the thumbnail images are preferentially arranged.

In addition, in the layout selection icon L2 illustrated in FIG. 6, when the right upper area of the layout indicated by the reference numeral R23 is selected by a drag operation on a window, as illustrated in FIG. 16(B), the information processing apparatus 10 arranges the window in the right upper second display area and arranges the thumbnail images of other windows in the right lower third display area. At this time, even if there is already a window arranged in the right lower third display area, the thumbnail images are preferentially arranged.

In addition, in the layout selection icon L2 illustrated in FIG. 6, when the right lower area of the layout indicated by the reference numeral R23 is selected by a drag operation on a window, as illustrated in FIG. 16(C), the information processing apparatus 10 arranges the window in the right lower third display area and arranges the thumbnail images of other windows in the left first display area. At this time, even if there is already a window arranged in the left first display area, the thumbnail images are preferentially arranged.

In addition, when any of the thumbnail images arranged in the right upper second display area illustrated in FIG. 16(A) is selected, similarly to the example illustrated in FIG. 16(B), the information processing apparatus 10 arranges the window corresponding to the selected thumbnail image in the right upper second display area and arranges the thumbnail images of the other windows in the right lower third display area. Even if a window is already arranged in the display area in which the thumbnail images are to be arranged, the thumbnail images are preferentially arranged (for example, arranged on the upper layer). Subsequently, when any of the thumbnail images arranged in the right lower third display area is selected, the information processing apparatus 10 arranges the window corresponding to the selected thumbnail image in the right lower third display area. At this time, the window that is already arranged continues to be arranged in the left first display area.

As described above, when a thumbnail image is selected in the second display area in FIG. 16(A), a window is displayed in the second display area and the thumbnail image is displayed in the third display area, but when a thumbnail image is subsequently selected in the third display area, a window is displayed in the third display area but no thumbnail image is displayed. That is, the thumbnail display ends at a time point (that is, the end of a first round) at which a window is displayed in the order of the first display area, the second display area, and the third display area and one round is completed. In addition, when a thumbnail image is selected in the third display area in FIG. 16(B), a window is displayed in the third display area and the thumbnail image is displayed in the first display area, but when a thumbnail image is subsequently selected in the first display area, a window is displayed in the first display area but no thumbnail image is displayed. That is, the thumbnail display ends at a time point (that is, the end of a first round) at which a window is displayed in the order of the second display area, the third display area, and the first display area and one round is completed. In addition, when a thumbnail image is selected in the first display area in FIG. 16(C), a window is displayed in the first display area and the thumbnail image is displayed in the second display area, but when a thumbnail image is subsequently selected in the second display area, a window is displayed in the second display area but no thumbnail image is displayed. That is, the thumbnail display ends at a time point (that is, the end of a first round) at which a window is displayed in the order of the third display area, the first display area, and the second display area and one round is completed.

In a state in which the thumbnail images are displayed, when an operation (for example, touch operation) is performed to select an area other than the thumbnail images, at that point, the thumbnail display ends. In addition, the thumbnail display does not have to end at the end of the first round, and the thumbnail images may continue to be arranged in the display area determined according to a certain arrangement rule (in a certain arrangement order).

FIG. 17 is a view illustrating a sixth example of the rule for arranging the thumbnail images according to the present embodiment. FIG. 17 illustrates an example of the rule for arranging the thumbnail images in a layout in which the screen area of the display is split into three display areas by splitting the screen area into two left and right display areas and further splitting the split left display area into two upper and lower display areas. This layout corresponds to the layout indicated by the reference numeral R24 of the layout selection icon L2 illustrated in FIG. 6.

Here, the left upper display area is referred to as a first display area (referred to as “1”), the right display area is referred to as a second display area (referred to as “2”), and the left lower display area is referred to as a third display area (referred to as “3”). In addition, a display area surrounded by a circle among “1”, “2”, and “3” indicates a display area in which a window is arranged by the snap function. In addition, starting from the display area in which a window is arranged by the snap function, the display area at the tip of an arrow indicates the display area in which the thumbnail images are arranged.

In the layout selection icon L2 illustrated in FIG. 6, when the left upper area of the layout indicated by the reference numeral R24 is selected by a drag operation on a window, as illustrated in FIG. 17(A), the information processing apparatus 10 arranges the window in the left upper first display area and arranges the thumbnail images of other windows in the right second display area. At this time, even if there is already a window arranged in the right second display area, the thumbnail images are preferentially arranged.

In addition, in the layout selection icon L2 illustrated in FIG. 6, when the right area of the layout indicated by the reference numeral R24 is selected by a drag operation on a window, as illustrated in FIG. 17(B), the information processing apparatus 10 arranges the window in the right second display area and arranges the thumbnail images of other windows in the left lower third display area. At this time, even if there is already a window arranged in the left lower third display area, the thumbnail images are preferentially arranged.

In addition, in the layout selection icon L2 illustrated in FIG. 6, when the left lower area of the layout indicated by the reference numeral R24 is selected by a drag operation on a window, as illustrated in FIG. 17(C), the information processing apparatus 10 arranges the window in the left lower third display area and arranges the thumbnail images of other windows in the right upper first display area. At this time, even if there is already a window arranged in the right upper first display area, the thumbnail images are preferentially arranged.

In addition, when any of the thumbnail images arranged in the right second display area illustrated in FIG. 17(A) is selected, similarly to the example illustrated in FIG. 17(B), the information processing apparatus 10 arranges the window corresponding to the selected thumbnail image in the right second display area and arranges the thumbnail images of the other windows in the left lower third display area. Even if a window is already arranged in the display area in which the thumbnail images are to be arranged, the thumbnail images are preferentially arranged (for example, arranged on the upper layer). Subsequently, when any of the thumbnail images arranged in the left lower third display area is selected, the information processing apparatus 10 arranges the window corresponding to the selected thumbnail image in the left lower third display area. At this time, the window that is already arranged continues to be arranged in the left upper first display area.

As described above, when a thumbnail image is selected in the second display area in FIG. 17(A), a window is displayed in the second display area and the thumbnail image is displayed in the third display area, but when a thumbnail image is subsequently selected in the third display area, a window is displayed in the third display area but no thumbnail image is displayed. That is, the thumbnail display ends at a time point (that is, the end of a first round) at which a window is displayed in the order of the first display area, the second display area, and the third display area and one round is completed. In addition, when a thumbnail image is selected in the third display area in FIG. 17(B), a window is displayed in the third display area and the thumbnail image is displayed in the first display area, but when a thumbnail image is subsequently selected in the first display area, a window is displayed in the first display area but no thumbnail image is displayed. That is, the thumbnail display ends at a time point (that is, the end of a first round) at which a window is displayed in the order of the second display area, the third display area, and the first display area and one round is completed. In addition, when a thumbnail image is selected in the first display area in FIG. 17(C), a window is displayed in the first display area and the thumbnail image is displayed in the second display area, but when a thumbnail image is subsequently selected in the second display area, a window is displayed in the second display area but no thumbnail image is displayed. That is, the thumbnail display ends at a time point (that is, the end of a first round) at which a window is displayed in the order of the third display area, the first display area, and the second display area and one round is completed.

In a state in which the thumbnail images are displayed, when an operation (for example, touch operation) is performed to select an area other than the thumbnail images, at that point, the thumbnail display ends. In addition, the thumbnail display does not have to end at the end of the first round, and the thumbnail images may continue to be arranged in the display area determined according to a certain arrangement rule (in a certain arrangement order).

In any of the above-described layouts, a previously snapped window maintains the snapped state thereof (arrangement and size) even if the window is subsequently overwritten and snapped to another window. In addition, when an operation is performed on a position other than the thumbnail image, the snap function ends, and only the arrangement state of the snapped window remains, and the display of the thumbnail image also ends.

### [Configuration of Information Processing Apparatus]

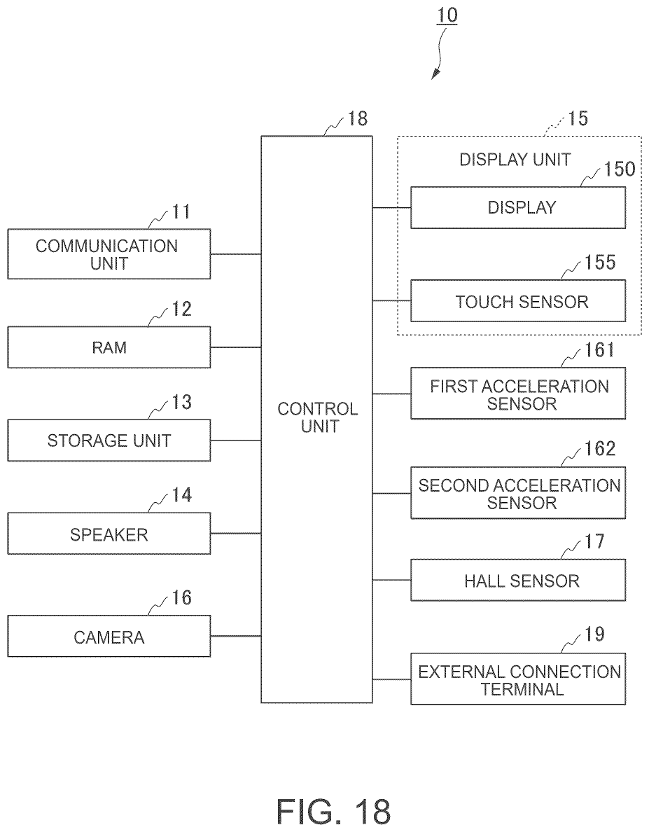

Hereinafter, a specific configuration of the information processing apparatus 10 will be described. FIG. 18 is a block view illustrating an example of a hardware configuration of the information processing apparatus 10 according to the present embodiment. The information processing apparatus 10 includes a communication unit 11, a random access memory (RAM) 12, a storage unit 13, a speaker 14, a display unit 15, a camera 16, a first acceleration sensor 161, and a second acceleration sensor 162, a hall sensor 17, a control unit 18, and an external connection terminal 19. These units are communicably connected to each other via a bus or the like.

The communication unit 11 includes, for example, digital input/output ports such as a plurality of Ethernet (registered trademark) ports or a plurality of universal serial buses (USB), and a communication device that performs wireless communication such as Bluetooth (registered trademark) or Wi-Fi (registered trademark). For example, the communication unit 11 can communicate with the external keyboard 30 or the like described above by using Bluetooth (registered trademark).

A program or data for the process executed by the control unit 18 is loaded in the RAM 12, and various types of data are saved or deleted as appropriate. For example, the RAM 12 also functions as a display video memory (V-RAM) for display of the display 150. As an example, the RAM 12 functions as a video memory for data displayed in each display area within the screen area of the display 150 (or the display 250 when the external display device 20 is connected). In addition, the RAM 12 stores information about running apps, which apps are being used among running apps (apps in active windows), information about other apps in inactive windows, information such as in which display area each window is displayed, in which layer each window is arranged, the size of the window, and whether or not the window is minimized. Since the RAM 12 is a volatile memory, the data is not held when the supply of power to the RAM 12 is stopped. The data that needs to be held when the supply of power to the RAM 12 is stopped is transferred to the storage unit 13.

The storage unit 13 includes any one or more of a solid state drive (SSD), a hard disk drive (HDD), a read only memory (ROM), a Flash-ROM, and the like. For example, the storage unit 13 saves a program or setting data of a basic input output system (BIOS), a program of an operating system (OS) or an app operating on the Os, various types of data used in the app, and the like.

The speaker 14 outputs an electronic sound, a voice, or the like.

The display unit 15 is provided with the display 150 and a touch sensor 155. As described above, the display 150 is a flexible display that can be bent according to the opening angle θ due to the relative rotation of the first chassis 101 and the second chassis 102. The display 150 performs display corresponding to each display mode described with reference to FIG. 4 according to the control of the control unit 18. The touch sensor 155 is provided on the screen of the display 150, and detects the touch operation on the screen. For example, the touch sensor 155 detects the touch operation on the display area DA in the one-screen mode. In addition, the touch sensor 155 detects the touch operation on one or both of the first display area DA1 and the second display area DA2 in the two-screen mode. A tap operation, a slide operation, a flick operation, a swipe operation, a pinch operation, and the like are included in the touch operation. The touch sensor 155 detects the touch operation to output operation information based on the detected operation to the control unit 18.

The camera 16 includes a lens, an imaging element, and the like. The camera 16 captures an image (a still image or a moving image) according to the control of the control unit 18 to output data of the captured image.

The first acceleration sensor 161 is provided inside the first chassis 101, and detects the orientation of the first chassis 101 and the change in the orientation. For example, assuming that a direction parallel to a longitudinal direction of the first display area DA1 is an X1 direction, a direction parallel to a lateral direction is a Y1 direction, and a direction perpendicular to the X1 direction and the Y1 direction is a Z1 direction, the first acceleration sensor 161 detects acceleration in each of the X1 direction, the Y1 direction, and the Z1 direction to output the detection result to the control unit 18.

The second acceleration sensor 162 is provided inside the second chassis 102, and detects the orientation of the second chassis 102 and the change in the orientation. For example, assuming that a direction parallel to a longitudinal direction of the second display area DA2 is an X2 direction, a direction parallel to a lateral direction is a Y2 direction, and a direction perpendicular to the X2 direction and the Y2 direction is a Z2 direction, the second acceleration sensor 162 detects acceleration in each of the X2 direction, the Y2 direction, and the Z2 direction to output the detection result to the control unit 18.

The hall sensor 17 is provided to detect the connection with the keyboard 30. For example, when the keyboard 30 is placed on the second display area DA2 of the second chassis 102, a magnetic field is changed due to approaching of the magnet provided in the inner portion of the bottom surface of the keyboard 30, and the detection value (output value) of the hall sensor 17 is changed. In other words, the hall sensor 17 outputs different detection results according to whether or not the keyboard 30 is placed. Here, the hall sensor 17 is used to detect whether or not the keyboard 30 is placed, but the detection method is not limited thereto, and any detection method can be used.

The external connection terminal 19 is a connection terminal for connecting to the external display device 20 (external display). For example, the external connection terminal 19 is an HDMI (registered trademark) terminal, a USB Type-C terminal, a display port, or the like. The information processing apparatus 10 and the external display device 20 may be connected wirelessly.

The control unit 18 includes a processor such as a central processing unit (CPU), a graphic processing unit (GPU), or a microcomputer, and realizes various functions by the processor executing the programs (various programs such as the BIOS, the OS, and the app operating on the OS) stored in the storage unit 13 or the like. For example, the control unit 18 detects the posture (orientation) of the information processing apparatus 10 based on the detection results of the first acceleration sensor 161 and the second acceleration sensor 162. In addition, the control unit 18 detects, based on the detection results of the first acceleration sensor 161 and the second acceleration sensor 162, whether the information processing apparatus 10 is in the open state or closed state, and whether the information processing apparatus 10 is in the bent form or the flat form in the open state, or the like.

In addition, the control unit 18 detects the connection with the keyboard 30 based on the detection result of the hall sensor 17. The connection with the keyboard 30 refers to the placement of the keyboard 30 on the second display area DA2, and does not refer to communication connection. The control unit 18 detects the communication connection with the keyboard 30 by using a function of Bluetooth (registered trademark) or the like.

In addition, the control unit 18 controls the switching of the display mode described with reference to FIGS. 4 and 5 by detecting the state of the system, the posture (orientation) of the information processing apparatus 10, whether the information processing apparatus 10 is in the open or closed state, whether the information processing apparatus 10 is in the bent form or flat form in the open state, whether the information processing apparatus 10 is connected to the keyboard 30, and the like.

In addition, the control unit 18 controls the display layout change process by using the snap function of snapping (arranging) a window to a desired display area within the screen area. For example, the control unit 18 controls the display of the display selection icon and the layout selection icon described with reference to FIGS. 6 to 11, and the snap function of arranging a window in the display area of the selected display. In addition, the control unit 18 controls the arrangement of thumbnail images to arrange the thumbnail images according to the arrangement rule when a window is arranged by the snap function.

Next, the following is a detailed description of the display layout change process by the snap function among the processes executed by the control unit 18. In the following description, as illustrated in FIG. 7, the information processing apparatus 10 will be described as being connected to the external display device 20 and controlling display of the embedded display and the external display.

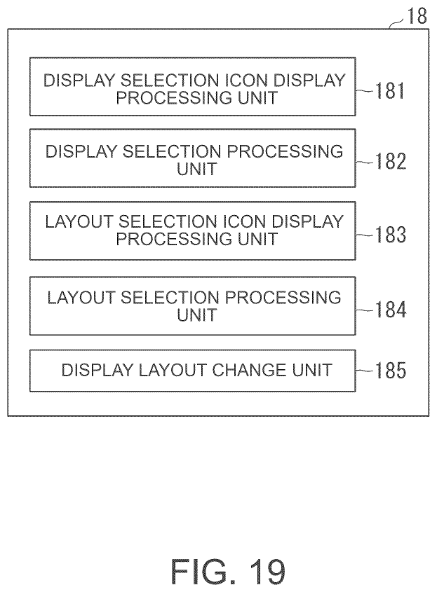

FIG. 19 is a block view illustrating an example of a functional configuration related to the display layout change process of the information processing apparatus 10 according to the present embodiment. As a functional configuration in which the CPU executes processing based on the OS or programs running on the OS, and the like, the control unit 18 includes a display selection icon display processing unit 181, a display selection processing unit 182, a layout selection icon display processing unit 183, a layout selection processing unit 184, and a display layout change unit 185.

The display selection icon display processing unit 181 performs the display process of display selection icons. For example, when a drag operation is accepted for a window displayed on at least one of the screen area of the embedded display and the screen area of the external display, the display selection icon display processing unit 181 displays the display selection icons G1 in the screen area of the display in which a drag operation is started (see FIG. 8). The display selection icons G1 include an embedded display icon G11 corresponding to the screen area of the embedded display, and an external display icon G12 corresponding to the screen area of the external display.

When not connected to an external display, the display selection icon display processing unit 181 includes only the embedded display icon G11 in the display selection icons G1.

The display selection processing unit 182 selects the screen area corresponding to the icon selected by a drag operation between the embedded display icon G11 and the external display icon G12 as a display for displaying a window being dragged.

The layout selection icon display processing unit 183 newly displays a layout selection icon from which a display area can be selected, in which the window is to be displayed within the screen area of the display selected by the display selection processing unit 182 (see FIG. 9). For example, the layout selection icon display processing unit 183 displays the layout selection icon L1 illustrated in FIG. 6(A) when the usage form is “Portrait (or Clamshell)”, and displays the layout selection icon L2 illustrated in FIG. 6(B) when the usage form is “Landscape”.

The layout selection processing unit 184 selects the display area selected by the drag operation on the layout selection icon as a display area for displaying a window being dragged (see FIG. 10).

In response to the completion of the drag operation on the window, the display layout change unit 185 arranges the window in the display area selected by the layout selection processing unit 184 within the screen area of the display selected by the display selection processing unit 182.

For example, when the layout indicated by the reference numeral R11 in the layout selection icon L1 illustrated in FIG. 6 or the layout indicated by the reference numeral R21 in the layout selection icon L2 is selected, the display layout change unit 185 performs a first display control process of arranging the dragged window as one display area on the screen area of the display.

In addition, the display layout change unit 185 performs a second display control process of splitting the screen area of a display into a plurality of display areas and arranging a window. For example, when the layout indicated by the reference numeral R12 in the layout selection icon L1 illustrated in FIG. 6 or the layout indicated by the reference numeral R22 in the layout selection icon L2 is selected, the display layout change unit 185 splits the screen area of a display into two display areas and arranges the dragged window in one of the two display areas (the selected display area). Further, when a dragged window is arranged in one of the two display areas, the display layout change unit 185 arranges the thumbnail images corresponding to one or a plurality of other windows other than the window in the other of the two display areas.

In addition, when the layout indicated by the reference numerals R13 and R14 in the layout selection icon L1 illustrated in FIG. 6 or the layout indicated by the reference numerals R23 and R24 in the layout selection icon L2 is selected, the display layout change unit 185 splits the screen area of a display into three display areas and arranges the dragged window in one of the three display areas (the selected display area).

Further, when a dragged window is arranged in one of three display areas, the display layout change unit 185 arranges the thumbnail images corresponding to one or a plurality of other windows other than the window in one of the other display areas of the three display areas. At this time, the display layout change unit 185 determines the display area in which the thumbnail images are to be arranged in the display area in which a window is to be arranged, according to a predetermined certain arrangement rule (in a certain arrangement order). For example, the certain arrangement rule (in a certain arrangement order) is an order in a clockwise order.

In addition, even if any of the windows is already arranged, the display layout change unit 185 preferentially arranges the thumbnail images in the display area in which the thumbnail images as determined by a certain arrangement rule (in a certain arrangement order) are to be arranged.

### [Operation of Display Layout Change Process]

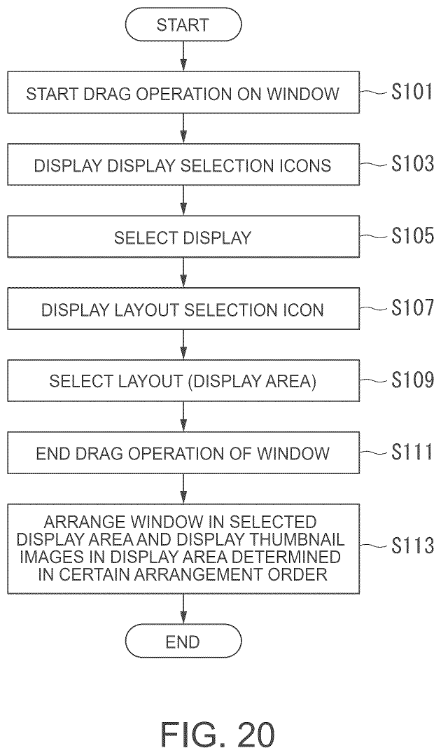

Next, the operation of the display layout change process executed by the control unit 18 will be described. FIG. 20 is a flowchart illustrating an example of the display layout change process according to the present embodiment.

(Step S101) When the control unit 18 accepts that a drag operation has been started on the window displayed on the screen area of the embedded display or the external display, the process advances to step S103.

(Step S103) The control unit 18 displays the display selection icons G1 on the screen area of the display on which the drag operation is started, between the embedded display and the external display (see FIG. 8). For example, the control unit 18 displays the embedded display icon G11 and the external display icon G12 included in the display selection icons G1 with different designs (figures, pictures) imitating the types of the respective displays. Then, the process advances to step S105.

(Step S105) The control unit 18 selects the screen area corresponding to the icon selected by a drag operation between the embedded display icon G11 and the external display icon G12 as a screen area of a display for displaying the window being dragged (see FIG. 9). Then, the process advances to step S107.

(Step S107) The control unit 18 newly displays a layout selection icon from which a display area can be selected, in which a window is to be displayed within the screen area of the display selected in step S105 (see FIG. 9). For example, the control unit 18 displays the layout selection icon L1 illustrated in FIG. 6(A) when the usage form is “Portrait (or Clamshell)”, and displays the layout selection icon L2 illustrated in FIG. 6(B) when the usage form is “Landscape”. Then, the process advances to step S109.

(Step S109) The control unit 18 selects the display area selected by the drag operation on the layout selection icon as a display area for displaying the window being dragged. Then, the process advances to step S111.

(Step S111) When the control unit 18 accepts that a drag operation has been completed on the window, the process advances to step S113.

(Step S113) The control unit 18 changes the display position of the dragged window and arranges the window in the display area within the screen area of the selected display. In addition, the control unit 18 arranges the thumbnail images corresponding to one or a plurality of other windows other than the dragged window in the display area determined according to a certain arrangement rule (in a certain arrangement order).

For example, as described with reference to FIGS. 12 to 17, the control unit 18 arranges the thumbnail images according to a certain arrangement rule (for example, a clockwise order).

Specifically, for example, when a window is arranged by splitting the screen area of a display into two upper and lower display areas as illustrated in FIG. 12, and when arranging a first window (for example, a window snapped by a drag operation) in the upper first display area of the two split display areas, the control unit 18 arranges the thumbnail images in the lower second display area (see FIG. 12(A)). In addition, when arranging the first window in the second display area, the control unit 18 arranges the thumbnail images in the first display area (see FIG. 12(B)).

As described above, in the information processing apparatus 10, when a window is arranged by splitting the screen area into two upper and lower display areas, for example, the display area in which the thumbnail images of other windows are to be arranged with respect to the window snapped by a drag operation is determined according to a certain arrangement rule (in a certain arrangement order), which is easy for the user to understand. At this time, whether or not another window is already arranged in the respective area by a previous snap operation does not affect, and even if another window is arranged, a newly selected window will be arranged on top of the window.

In addition, for example, when a window is arranged by splitting the screen area of a display into two left and right display areas as illustrated in FIG. 13, and when arranging a first window (for example, a window snapped by a drag operation) in the left first display area of the two split display areas, the control unit 18 arranges the thumbnail images in the right second display area (see FIG. 13(A)). In addition, when arranging the first window in the second display area, the control unit 18 arranges the thumbnail images in the first display area (see FIG. 13(B)).

As described above, in the information processing apparatus 10, when a window is arranged by splitting the screen area into two left and right display areas, for example, the display area in which the thumbnail images of other windows are to be arranged with respect to the window snapped by a drag operation is determined according to a certain arrangement rule (in a certain arrangement order), which is easy for the user to understand.

In addition, for example, as illustrated in FIG. 14, into two upper and lower display areas and further splitting the split lower display area into two left and right display areas, and when arranging a first window (for example, a window snapped by a drag operation) in the upper first display area of the three split display areas, the control unit 18 arranges the thumbnail images in the lower right second display area (see FIG. 14(A)). In addition, when arranging the first window in the second display area, the control unit 18 arranges the thumbnail images in the lower left third display area (see FIG. 14(B)) and arranges the thumbnail images in the first display area when arranging the first window in the third display area (see FIG. 14(C)).

As described above, in the information processing apparatus 10, when a window is arranged by splitting the screen area into three display areas, for example, the display area in which the thumbnail images of other windows are to be arranged with respect to the window snapped by a drag operation is determined according to a certain arrangement rule (in a certain arrangement order), which is easy for the user to understand.

In addition, for example, as illustrated in FIG. 15, into two upper and lower display areas and further splitting the split upper display area into two left and right display areas, and when arranging a first window (for example, a window snapped by a drag operation) in the upper left first display area of the three split display areas, the control unit 18 arranges the thumbnail images in the upper right second display area (see FIG. 15(A)). In addition, the control unit 18 arranges the thumbnail images in the lower third display area when arranging the first window in the second display area (see FIG. 15(B)), and arranges the thumbnail images in the first display area when arranging the first window in the third display area (see FIG. 15(C)).

As described above, in the information processing apparatus 10, when a window is arranged by splitting the screen area into three display areas, for example, the display area in which the thumbnail images of other windows are to be arranged with respect to the window snapped by a drag operation is determined according to a certain arrangement rule (in a certain arrangement order), which is easy for the user to understand.

In addition, for example, as illustrated in FIG. 16, into two left and right display areas and further splitting the split right display area into two upper and lower display areas, and when arranging a first window (for example, a window snapped by a drag operation) in the left first display area of the three split display areas, the control unit 18 arranges the thumbnail images in the right upper second display area (see FIG. 16(A)). In addition, the control unit 18 arranges the thumbnail images in the right lower third display area when arranging the first window in the second display area (see FIG. 16(B)), and arranges the thumbnail images in the first display area when arranging the first window in the third display area (see FIG. 16(C)).

As described above, in the information processing apparatus 10, when a window is arranged by splitting the screen area into three display areas, for example, the display area in which the thumbnail images of other windows are to be arranged with respect to the window snapped by a drag operation is determined according to a certain arrangement rule (in a certain arrangement order), which is easy for the user to understand.

In addition, for example, as illustrated in FIG. 17, into two left and right display areas and further splitting the split left display area into two upper and lower display areas, and when arranging a first window (for example, a window snapped by a drag operation) in the left upper first display area of the three split display areas, the control unit 18 arranges the thumbnail images in the right second display area (see FIG. 17(A)). In addition, the control unit 18 arranges the thumbnail images in the left lower third display area when arranging the first window in the second display area (see FIG. 17(B)), and arranges the thumbnail images in the first display area when arranging the first window in the third display area (see FIG. 17(C)).

As described above, in the information processing apparatus 10, when a window is arranged by splitting the screen area into three display areas, for example, the display area in which the thumbnail images of other windows are to be arranged with respect to the window snapped by a drag operation is determined according to a certain arrangement rule (in a certain arrangement order), which is easy for the user to understand.

In the present embodiment, as an example of splitting the screen area of a display into a plurality of display areas, an example of splitting the screen area into two display areas and an example of splitting the screen area into three display areas are shown, but another example will be described here. For example, the information processing apparatus 10 may arrange a window by splitting the screen area of a display into four or more display areas and determine the display area in which the thumbnail images are to be arranged, according to a certain arrangement rule (in a certain arrangement order) in that case as well.

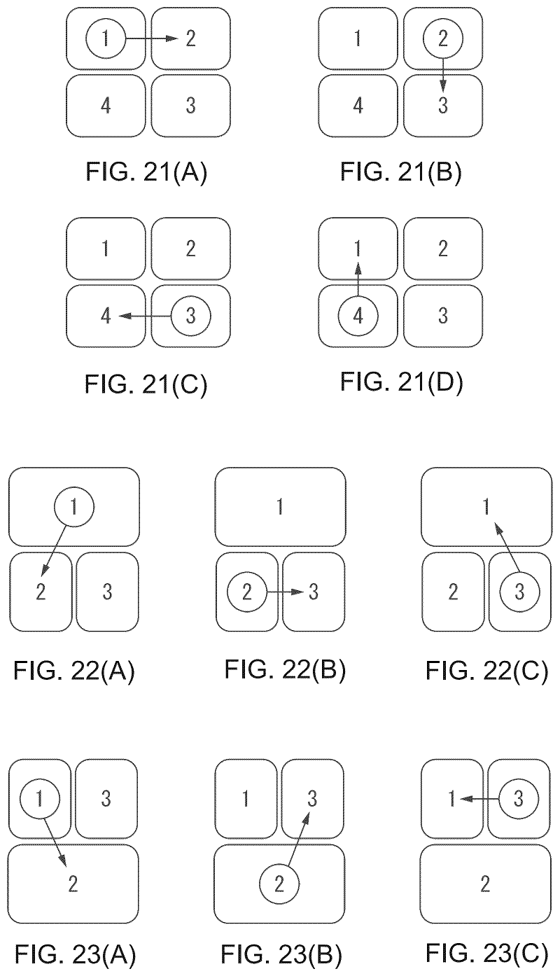

FIG. 21 is a view illustrating another example of the rule for arranging the thumbnail images according to the present embodiment. FIG. 21 illustrates an example of the rule for arranging the thumbnail images in a layout in which the screen area of a display is split into four display areas by splitting the screen area into two upper and lower display areas and further splitting each of the split upper and lower display areas into two left and right areas (that is, splitting the screen area into four display areas: upper, lower, left and right).

Here, the left upper display area is referred to as a first display area (referred to as “1”), the right upper display area is referred to as a second display area (referred to as “2”), the right lower display area is referred to as a third display area (referred to as “3”), and the left lower display area is referred to as a fourth display area (referred to as “4”). In addition, a display area surrounded by a circle among “1”, “2”, “3”, and “4” indicates a display area in which a window is arranged by the snap function. In addition, starting from the display area in which a window is arranged by the snap function, the display area at the tip of an arrow indicates the display area in which the thumbnail images are arranged.

For example, as illustrated in FIG. 21(A), when the window snapped by a drag operation is arranged in the left upper first display area, the control unit 18 arranges the thumbnail images of the other windows in the right upper second display area. In addition, as illustrated in FIG. 21(B), when the window snapped by a drag operation is arranged in the right upper second display area, the control unit 18 arranges the thumbnail images of the other windows in the right lower third display area. In addition, as illustrated in FIG. 21(C), when the window snapped by a drag operation is arranged in the right lower third display area, the control unit 18 arranges the thumbnail images of the other windows in the left lower fourth display area. In addition, as illustrated in FIG. 21(D), when the window snapped by a drag operation is arranged in the left lower fourth display area, the control unit 18 arranges the thumbnail images of the other windows in the left upper first display area.

As described above, when a window is arranged by split the screen area of a display into four upper, lower, left, and right display areas as illustrated in FIG. 21, and when arranging a first window (for example, a window snapped by a drag operation) in the left upper first display area of the four split display areas, the control unit 18 arranges the thumbnail images in the right upper second display area (see FIG. 21(A)), and arranges the thumbnail images in the right lower third display area when arranging the first window in the second display area (see FIG. 21(B)). In addition, the control unit 18 arranges the thumbnail images in the left lower fourth display area when arranging the first window in the third display area (see FIG. 21(C)), and arranges the thumbnail images in the first display area when arranging the first window in the fourth display area (see FIG. 21(D)).

As described above, in the information processing apparatus 10, when a window is arranged by splitting the screen area into four display areas, for example, the display area in which the thumbnail images of other windows are to be arranged with respect to the window snapped by a drag operation is determined according to a certain arrangement rule (in a certain arrangement order), which is easy for the user to understand.

### SUMMARY OF EMBODIMENT

As described above, the information processing apparatus 10 according to the present embodiment includes the storage unit 13 (an example of a memory) that stores a program of an application and the control unit 18 (for example, an example of a processor such as a CPU, a GPU, or a microcomputer) that performs control of arranging and displaying a window of a running application in the screen area of the display 150 (or the display 250) by executing the program of the application stored in the storage unit 13. The control unit 18 performs a display control process of splitting the screen area of the display 150 (or the display 250) into a plurality of display areas and arranging a window. In addition, in the display control process, when arranging a first window (for example, a window snapped by a drag operation) of the windows of a running application in one of the plurality of display areas, the control unit 18 arranges the thumbnail images corresponding to one or a plurality of second windows other than the first window in a display area other than the one of the plurality of display areas. Then, the control unit 18 determines the display area in which the thumbnail images are to be arranged with respect to one display area in which the first window is to be arranged, according to a certain arrangement rule (in a certain arrangement order).

As a result, in the information processing apparatus 10, when a window is arranged by splitting the screen area into a plurality of display areas, for example, the display area in which the thumbnail images of other windows are to be arranged with respect to the window snapped by a drag operation is always determined according to a certain arrangement rule (in a certain arrangement order), which is easy for the user to understand. Therefore, in the information processing apparatus 10, it is possible to easily arrange a window in a layout in which the screen area is split into a plurality of display areas as intended by the user.

For example, in the display control process, even if any of the windows is already arranged, the control unit 18 preferentially arranges the thumbnail images in the display area in which the thumbnail images as determined by a certain arrangement rule (in a certain arrangement order) are to be arranged.

As a result, in the information processing apparatus 10, when a window is arranged by splitting the screen area into a plurality of display areas, for example, the display area in which the thumbnail images of other windows are to be arranged with respect to the window snapped by a drag operation is always determined according to a certain arrangement rule (in a certain arrangement order), regardless of whether the window is already arranged in the display area or not, which is easy for the user to understand, and it is easy to arrange the window as intended.

In addition, the certain arrangement rule (certain arrangement order) for arranging the thumbnail images described above may be an order in a clockwise order. That is, the control unit 18 determines the display area in which the thumbnail images are to be arranged, according to an arrangement order in a clockwise order with respect to the display area in which a first window (for example, a window snapped by a drag operation) is to be arranged.

Accordingly, in the information processing apparatus 10, when a window is arranged by splitting the screen area into a plurality of display areas, for example, the display area in which the thumbnail images of other windows are to be arranged with respect to the window snapped by a drag operation is always determined according to the clockwise order, which is easy for the user to understand.

In addition, the control method in the information processing apparatus 10 according to the present embodiment includes, via the control unit 18 (for example, an example of a processor such as a CPU, a GPU, or a microcomputer) that performs control of arranging and displaying windows of a running application in the screen area of the display 150 (or the display 250), a step of splitting the screen area of the display 150 (or the display 250) into a plurality of display areas and arranging a first window (for example, a window snapped by a drag operation) of the windows in one of the plurality of display areas and a step of arranging thumbnail images corresponding to one or a plurality of second windows other than the first window in a display area other than the one display area of the plurality of display areas and determining a display area in a certain arrangement order, in which the thumbnail images are to be arranged with respect to the one display area in which the first window is to be arranged.

As a result, in the control method in the information processing apparatus 10, when a window is arranged by splitting the screen area into a plurality of display areas, for example, the display area in which the thumbnail images of other windows are to be arranged with respect to the window snapped by a drag operation is always determined according to a certain arrangement rule (in a certain arrangement order), which is easy for the user to understand. Therefore, in the control method in the information processing apparatus 10, it is possible to easily arrange a window in a layout in which the screen area is split into a plurality of display areas as intended by the user.

### Second Embodiment

Next, a second embodiment of the present invention will be described. In the first embodiment, an example has been described, in which the certain arrangement rule (certain arrangement order) for arranging the thumbnail images is an order in a clockwise order, but the certain arrangement order is not limited to the order in a clockwise order, and may be, for example, an order in a counterclockwise order. Hereinafter, an example of a case where the rule for arranging the thumbnail images is in an order in a counterclockwise order will be described.

FIG. 22 is a view illustrating a first example of the rule for arranging the thumbnail images according to the present embodiment. FIG. 22 illustrates an example of the rule for arranging the thumbnail images in an order in a counterclockwise order in a layout similar to FIG. 14, in which the screen area of a display is split into three display areas by splitting the screen area into two upper and lower display areas and further splitting the split lower display area into two left and right display areas. This layout corresponds to the layout indicated by the reference numeral R13 of the layout selection icon L1 illustrated in FIG. 6.

Here, the upper display area is referred to as a first display area (referred to as “1”), the lower left display area is referred to as a second display area (referred to as “2”), and the lower right display area is referred to as a third display area (referred to as “3”). In addition, a display area surrounded by a circle among “1”, “2”, and “3” indicates a display area in which a window is arranged by the snap function. In addition, starting from the display area in which a window is arranged by the snap function, the display area at the tip of an arrow indicates the display area in which the thumbnail images are arranged.

For example, as illustrated in FIG. 22, when a window is arranged by splitting the screen area of a display into three display areas by splitting the screen area into two upper and lower display areas and further splitting the split lower display area into two left and right display areas, and when arranging a first window (for example, a window snapped by a drag operation) in the upper first display area of the three split display areas, the control unit 18 arranges the thumbnail images in the lower left second display area (see FIG. 22(A)). In addition, when arranging the first window in the lower left second display area, the control unit 18 arranges the thumbnail images in the lower right third display area (see FIG. 22(B)). In addition, when arranging the first window in the lower right third display area, the control unit 18 arranges the thumbnail images in the first display area (see FIG. 22(C)).

As a result, in the information processing apparatus 10, when a window is arranged by splitting the screen area into three display areas, for example, the display area in which the thumbnail images of other windows are to be arranged with respect to the window snapped by a drag operation is determined according to a certain arrangement rule (in a certain arrangement order), which is easy for the user to understand.

FIG. 23 is a view illustrating a second example of the rule for arranging the thumbnail images according to the present embodiment. FIG. 23 illustrates an example of the rule for arranging the thumbnail images in an order in a counterclockwise order in a layout similar to FIG. 15, in which the screen area of a display is split into three display areas by splitting the screen area into two upper and lower display areas and further splitting the split upper display area into two left and right display areas. This layout corresponds to the layout indicated by the reference numeral R14 of the layout selection icon L1 illustrated in FIG. 6.

Here, the upper left display area is referred to as a first display area (referred to as “1”), the lower display area is referred to as a second display area (referred to as “2”), and the upper right display area is referred to as a third display area (referred to as “3”). In addition, a display area surrounded by a circle among “1”, “2”, and “3” indicates a display area in which a window is arranged by the snap function. In addition, starting from the display area in which a window is arranged by the snap function, the display area at the tip of an arrow indicates the display area in which the thumbnail images are arranged.

For example, as illustrated in FIG. 23, when a window is arranged by splitting the screen area of a display into three display areas by splitting the screen area into two upper and lower display areas and further splitting the split upper display area into two left and right display areas, and when arranging a first window (for example, a window snapped by a drag operation) in the upper left first display area of the three split display areas, the control unit 18 arranges the thumbnail images in the lower second display area (see FIG. 23(A)). In addition, when arranging the first window in the lower second display area, the control unit 18 arranges the thumbnail images in the upper right third display area (see FIG. 23(B)). In addition, when arranging the first window in the upper right third display area, the control unit 18 arranges the thumbnail images in the upper left first display area (see FIG. 23(C)).

As a result, in the information processing apparatus 10, when a window is arranged by splitting the screen area into three display areas, for example, the display area in which the thumbnail images of other windows are to be arranged with respect to the window snapped by a drag operation is determined according to a certain arrangement rule (in a certain arrangement order), which is easy for the user to understand.

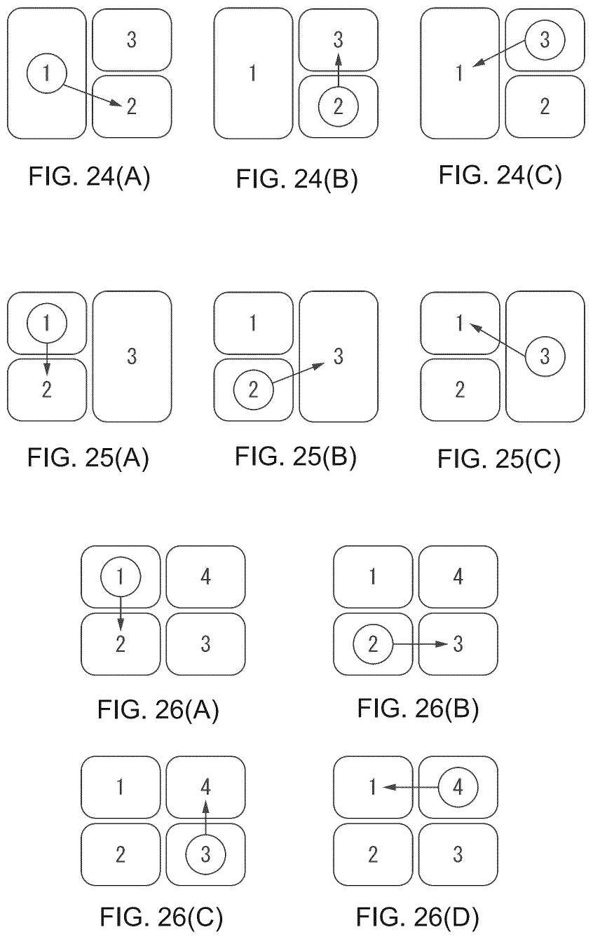

FIG. 24 is a view illustrating a third example of the rule for arranging the thumbnail images according to the present embodiment. FIG. 24 illustrates an example of the rule for arranging the thumbnail images in an order in a counterclockwise order in a layout similar to FIG. 16, in which the screen area of a display is split into three display areas by splitting the screen area into two left and right display areas and further splitting the split right display area into two upper and lower display areas. This layout corresponds to the layout indicated by the reference numeral R23 of the layout selection icon L2 illustrated in FIG. 6.

Here, the left display area is referred to as a first display area (referred to as “1”), the right lower display area is referred to as a second display area (referred to as “2”), and the right upper display area is referred to as a third display area (referred to as “3”). In addition, a display area surrounded by a circle among “1”, “2”, and “3” indicates a display area in which a window is arranged by the snap function. In addition, starting from the display area in which a window is arranged by the snap function, the display area at the tip of an arrow indicates the display area in which the thumbnail images are arranged.

For example, as illustrated in FIG. 24, when a window is arranged by splitting the screen area of a display into three display areas by splitting the screen area into two left and right display areas and further splitting the split right display area into two upper and lower display areas, and when arranging a first window (for example, a window snapped by a drag operation) in the left first display area of the three split display areas, the control unit 18 arranges the thumbnail images in the right lower second display area (see FIG. 24(A)). In addition, when arranging the first window in the right lower second display area, the control unit 18 arranges the thumbnail images in the right upper third display area (see FIG. 24(B)). In addition, when arranging the first window in the right upper third display area, the control unit 18 arranges the thumbnail images in the left first display area (see FIG. 24(C)).

As a result, in the information processing apparatus 10, when a window is arranged by splitting the screen area into three display areas, for example, the display area in which the thumbnail images of other windows are to be arranged with respect to the window snapped by a drag operation is determined according to a certain arrangement rule (in a certain arrangement order), which is easy for the user to understand.

FIG. 25 is a view illustrating a fourth example of the rule for arranging the thumbnail images according to the present embodiment. FIG. 25 illustrates an example of the rule for arranging the thumbnail images in an order in a counterclockwise order in a layout similar to FIG. 17, in which the screen area of a display is split into three display areas by splitting the screen area into two left and right display areas and further splitting the split left display area into two upper and lower display areas. This layout corresponds to the layout indicated by the reference numeral R24 of the layout selection icon L2 illustrated in FIG. 6.

Here, the left upper display area is referred to as a first display area (referred to as “1”), the left lower display area is referred to as a second display area (referred to as “2”), and the right display area is referred to as a third display area (referred to as “3”). In addition, a display area surrounded by a circle among “1”, “2”, and “3” indicates a display area in which a window is arranged by the snap function. In addition, starting from the display area in which a window is arranged by the snap function, the display area at the tip of an arrow indicates the display area in which the thumbnail images are arranged.

For example, as illustrated in FIG. 25, when a window is arranged by splitting the screen area of a display into three display areas by splitting the screen are into two left and right display areas and further splitting the split left display area into two upper and lower display areas, and when arranging a first window (for example, a window snapped by a drag operation) in the left upper first display area of the three split display areas, the control unit 18 arranges the thumbnail images in the left lower second display area (see FIG. 25(A)). In addition, when arranging the first window in the left lower second display area, the control unit 18 arranges the thumbnail images in the right third display area (see FIG. 25(B)). In addition, when arranging the first window in the right third display area, the control unit 18 arranges the thumbnail images in the left upper first display area (see FIG. 25(C)).

As a result, in the information processing apparatus 10, when a window is arranged by splitting the screen area into three display areas, for example, the display area in which the thumbnail images of other windows are to be arranged with respect to the window snapped by a drag operation is determined according to a certain arrangement rule (in a certain arrangement order), which is easy for the user to understand.

FIG. 26 is a view illustrating a fifth example of the rule for arranging the thumbnail images according to the present embodiment. FIG. 26 illustrates an example of the rule for arranging the thumbnail images in an order in a counterclockwise order in a layout similar to FIG. 21, in which the screen area of a display is split into four display areas by splitting the screen area into two upper and lower display areas and further splitting each of the split upper and lower display areas into two left and right areas (that is, splitting the screen area into four display areas: upper, lower, left and right).

Here, the left upper display area is referred to as a first display area (referred to as “1”), the left lower display area is referred to as a second display area (referred to as “2”), the right lower display area is referred to as a third display area (referred to as “3”), and the right upper display area is referred to as a fourth display area (referred to as “4”). In addition, a display area surrounded by a circle among “1”, “2”, “3”, and “4” indicates a display area in which a window is arranged by the snap function. In addition, the display area to which the tip of an arrow indicates a display area in which the thumbnail image is arranged, with the display area in which the window is arranged by the snap function as a starting point.

For example, when a window is arranged by splitting the screen area of a display into four upper, lower, left, and right display areas as illustrated in FIG. 26, and when arranging a first window (for example, a window snapped by a drag operation) in the left upper first display area of the four split display areas, the control unit 18 arranges the thumbnail images in the left lower second display area (see FIG. 26(A)). In addition, when arranging the first window in the left lower second display area, the control unit 18 arranges the thumbnail images in the right lower third display area (see FIG. 26(B)). In addition, when arranging the first window in the right lower third display area, the control unit 18 arranges the thumbnail images in the right upper fourth display area (see FIG. 26(C)). In addition, when arranging the first window in the right upper fourth display area, the control unit 18 arranges the thumbnail images in the left upper first display area (see FIG. 26(D)).

As a result, in the information processing apparatus 10, when a window is arranged by splitting the screen area into four display areas, for example, the display area in which the thumbnail images of other windows are to be arranged with respect to the window snapped by a drag operation is determined according to a certain arrangement rule (in a certain arrangement order), which is easy for the user to understand.

As described above, the information processing apparatus 10 may arrange the thumbnail images according to a certain arrangement rule (in a certain arrangement order) in a counterclockwise order.

Accordingly, in the information processing apparatus 10, when a window is arranged by splitting the screen area into a plurality of display areas, for example, the display area in which the thumbnail images of other windows are to be arranged with respect to the window snapped by a drag operation is always determined according to the counterclockwise order, which is easy for the user to understand.

### Third Embodiment

Next, a third embodiment of the present invention will be described. In the above-described embodiment, as an example of a layout in which the screen area of a display is split into a plurality of display areas, the examples of three-part layouts (see FIGS. 14 to 17 and FIGS. 21 to 25) and four-part layouts (see FIGS. 21 and 26) have been described, but a method of splitting the screen area is not limited to the examples described in the above embodiments. For example, a layout in which the screen area of a display is split into a plurality of display areas only in a left-right direction may be used, or a layout in which the screen area of a display is split into a plurality of display areas only in an up-down direction may be used. In the present embodiment, a rule for arranging the thumbnail images in another example of the layout when the screen area of a display is split into three display areas will be described.

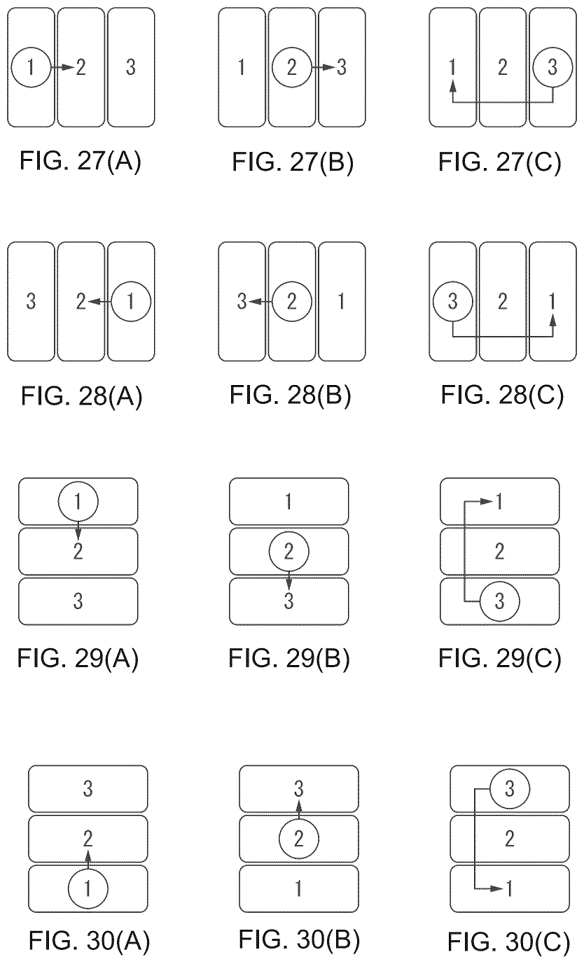

FIG. 27 is a view illustrating a first example of the rule for arranging the thumbnail images according to the present embodiment. FIG. 27 illustrates an example of the rule for arranging the thumbnail images in a layout in which the screen area of a display is split into three left and right display areas.

Here, the left display area is referred to as a first display area (referred to as “1”), the central display area is referred to as a second display area (referred to as “2”), and the right display area is referred to as a third display area (referred to as “3”). In addition, a display area surrounded by a circle among “1”, “2”, and “3” indicates a display area in which a window is arranged by the snap function. In addition, the display area to which the tip of an arrow indicates a display area in which the thumbnail image is arranged, with the display area in which the window is arranged by the snap function as a starting point.

When a window is arranged by splitting the screen area of a display into three display areas in a left-right direction as illustrated in FIG. 27, and when arranging a first window (for example, a window snapped by a drag operation) in the left first display area of the three split display areas, the control unit 18 arranges the thumbnail images in the central second display area (see FIG. 27(A)). In addition, when arranging the first window in the central second display area, the control unit 18 arranges the thumbnail images in the right third display area (see FIG. 27(B)). In addition, when arranging the first window in the right third display area, the control unit 18 arranges the thumbnail images in the left first display area (see FIG. 27(C)).

As described above, in a layout in which the screen area of a display is split into three display areas in a left-right direction, the information processing apparatus 10 arranges the thumbnail images in the rightward order with the respect to the display area of the window snapped by a drag operation, and determines the display area in which the thumbnail images are to be arranged in the order in which the thumbnail images return to the left (leftmost) display area after reaching the right (rightmost) display area (corresponding to a clockwise order).

As a result, in the information processing apparatus 10, even when a window is arranged by splitting the screen area into three display areas in the left-right direction, for example, the display area in which the thumbnail images of other windows are to be arranged with respect to the window snapped by a drag operation is determined according to a certain arrangement rule (in a certain arrangement order), which is easy for the user to understand.

FIG. 28 is a view illustrating a second example of the rule for arranging the thumbnail images according to the present embodiment. FIG. 28 illustrates an example of the rule for arranging the thumbnail images in the leftward order (corresponding to the clockwise order) in a layout similar to FIG. 27, in which the screen area of a display is split into three display areas in a left-right direction.

Here, the left display area is referred to as a first display area (referred to as “1”), the central display area is referred to as a second display area (referred to as “2”), and the right display area is referred to as a third display area (referred to as “3”). In addition, a display area surrounded by a circle among “1”, “2”, and “3” indicates a display area in which a window is arranged by the snap function. In addition, the display area to which the tip of an arrow indicates a display area in which the thumbnail image is arranged, with the display area in which the window is arranged by the snap function as a starting point.

When a window is arranged by splitting the screen area of a display into three display areas in a left-right direction as illustrated in FIG. 28, and when arranging a first window (for example, a window snapped by a drag operation) in the right first display area of the three split display areas, the control unit 18 arranges the thumbnail images in the central second display area (see FIG. 28(A)). In addition, when arranging the first window in the central second display area, the control unit 18 arranges the thumbnail images in the left third display area (see FIG. 28(B)). In addition, when arranging the first window in the left third display area, the control unit 18 arranges the thumbnail images in the right first display area (see FIG. 28(C)).

As described above, in a layout in which the screen area of a display is split into three display areas in a left-right direction, the information processing apparatus 10 arranges the thumbnail images in the leftward order with the respect to the display area of the window snapped by a drag operation, and determines the display area in which the thumbnail images are to be arranged in the order of returning to the right (rightmost) display area after reaching the left (leftmost) display area (corresponding to a counterclockwise order).

As a result, in the information processing apparatus 10, even when a window is arranged by splitting the screen area into three display areas in the left-right direction, for example, the display area in which the thumbnail images of other windows are to be arranged with respect to the window snapped by a drag operation is determined according to a certain arrangement rule (in a certain arrangement order), which is easy for the user to understand.

FIG. 29 is a view illustrating a third example of the rule for arranging the thumbnail images according to the present embodiment. FIG. 29 illustrates an example of the rule for arranging the thumbnail images in a layout in which the screen area of a display is split into three display areas in an up-down direction.

Here, the upper display area is referred to as a first display area (referred to as “1”), the central display area is referred to as a second display area (referred to as “2”), and the lower display area is referred to as a third display area (referred to as “3”). In addition, a display area surrounded by a circle among “1”, “2”, and “3” indicates a display area in which a window is arranged by the snap function. In addition, the display area to which the tip of an arrow indicates a display area in which the thumbnail image is arranged, with the display area in which the window is arranged by the snap function as a starting point.

When a window is arranged by splitting the screen area of a display into three display areas in an up-down direction as illustrated in FIG. 29, and when arranging a first window (for example, a window snapped by a drag operation) in the upper first display area of the three split display areas, the control unit 18 arranges the thumbnail images in the central second display area (see FIG. 29(A)). In addition, when arranging the first window in the central second display area, the control unit 18 arranges the thumbnail images in the lower third display area (see FIG. 29(B)). In addition, when arranging the first window in the lower third display area, the control unit 18 arranges the thumbnail images in the upper first display area (see FIG. 29(C)).

As described above, in a layout in which the screen area of a display is split into three display areas in an up-down direction, the information processing apparatus 10 arranges the thumbnail images in the downward order with the respect to the display area of the window snapped by a drag operation, and determines the display area in which the thumbnail images are to be arranged in the order of returning to the upper (uppermost) display area after reaching the lower (lowermost) display area.

As a result, in the information processing apparatus 10, even when a window is arranged by splitting the screen area into three display areas in the up-down direction, for example, the display area in which the thumbnail images of other windows are to be arranged with respect to the window snapped by a drag operation is determined according to a certain arrangement rule (in a certain arrangement order), which is easy for the user to understand.

FIG. 30 is a view illustrating a fourth example of the rule for arranging the thumbnail images according to the present embodiment. FIG. 30 illustrates an example of the rule for arranging the thumbnail images in a layout similar to FIG. 29, in which the screen area of a display is split into three display areas in the up-down direction in the upward order.

Here, the lower display area is referred to as a first display area (referred to as “1”), the central display area is referred to as a second display area (referred to as “2”), and the upper display area is referred to as a third display area (referred to as “3”). In addition, a display area surrounded by a circle among “1”, “2”, and “3” indicates a display area in which a window is arranged by the snap function. In addition, the display area to which the tip of an arrow indicates a display area in which the thumbnail image is arranged, with the display area in which the window is arranged by the snap function as a starting point.

When a window is arranged by splitting the screen area of a display into three display areas in an up-down direction as illustrated in FIG. 30, and when arranging a first window (for example, a window snapped by a drag operation) in the lower first display area of the three split display areas, the control unit 18 arranges the thumbnail images in the central second display area (see FIG. 30(A)). In addition, when arranging the first window in the central second display area, the control unit 18 arranges the thumbnail images in the upper third display area (see FIG. 30(B)). In addition, when arranging the first window in the upper third display area, the control unit 18 arranges the thumbnail images in the lower first display area (see FIG. 30(C)).

As described above, in a layout in which the screen area of a display is split into three display areas in an up-down direction, the information processing apparatus 10 arranges the thumbnail images in the upward order with the respect to the display area of the window snapped by a drag operation, and determines the display area in which the thumbnail images are to be arranged in the order of returning to the lower (lowermost) display area after reaching the upper (uppermost) display area.

As a result, in the information processing apparatus 10, even when a window is arranged by splitting the screen area into three display areas in the up-down direction, for example, the display area in which the thumbnail images of other windows are to be arranged with respect to the window snapped by a drag operation is determined according to a certain arrangement rule (in a certain arrangement order), which is easy for the user to understand.

Although the embodiments of the present invention have been described above in detail with reference to the accompanying drawings, a specific configuration is not limited to the above-described configuration, and various design changes and the like can be made without departing from the gist of the present invention. For example, the configurations described in the above-described embodiments may be optionally combined.

In the above-described embodiment, an example has been described, in which when splitting the screen area into a plurality of display areas and arranging a window, thumbnail images are arranged in other display areas due to the window snapped by a drag operation being arranged in one display area, but the arrangement of the window that results in the arrangement of the thumbnail images does not have to be due to the snap function. For example, when the thumbnail images are arranged in other display areas in response to a window being arranged in one display area by switching from the one-screen mode to the two-screen mode by the display mode switching control described with reference to FIGS. 4 and 5, the rule for arranging thumbnail images described in the above embodiment can be applied.

In addition, the display mode switching control described with reference to FIGS. 4 and 5 is the switching control between the one-screen mode, the two-screen mode, and the half-screen mode, but may include switching control between screen modes in which the screen area of a display is split into three or more display areas (for example, three-screen mode, four-screen mode, and the like). In addition, at this time, the rule for arranging thumbnail images described in the above embodiment can be applied in screen modes in which the screen area of a display is split into three or more display areas (for example, three-screen mode, four-screen mode, and the like).

In addition, in the information processing apparatus 10 according to the embodiment described above, one foldable display 150 is provided extending from the inner surface of the first chassis 101 to the inner surface of the second chassis 102, but the present invention is not limited thereto. For example, the information processing apparatus 10 may be configured to include a display only on the inner surface of the first chassis 101. In addition, the information processing apparatus 10 may be configured to include a display on each of the inner surface of the first chassis 101 and the inner surface of the second chassis 102.

In addition, in the embodiment described above, an example has been illustrated in which the plurality of displays whose display is controlled by the information processing apparatus 10 are two displays, the embedded display of the information processing apparatus 10 and the external display of the external display device 20, but the present invention is not limited thereto. When the information processing apparatus 10 is equipped with a plurality of embedded displays, the plurality of displays whose display is controlled may be the plurality of embedded displays. Further, when the information processing apparatus 10 is connected to a plurality of external display devices 20, the plurality of displays whose display is controlled may be the plurality of external displays, or the plurality of external displays and one or a plurality of embedded displays. That is, the plurality of displays whose display is controlled by the information processing apparatus 10 may be two displays, three or more displays, and may be either an embedded display or an external display.

In addition, in the embodiment described above, there are three types of layouts that can be selected from the layout selection icon L1 or L2 (see FIG. 6): a layout in which the entire screen area of the display 150 is one display area, a layout in which the screen area is split into two, upper and lower, and a layout in which the screen area is split into three, but the present invention is not limited thereto. For example, it may be possible to select only a part of the above three types of layouts, or it may be possible to select a layout in which the screen area is split into four or more display areas.

Further, in the embodiment described above, an example of touch operation on a plurality of touch panel displays that are configured by integrating an input unit (touch sensor) and a display unit is described, but the present invention is not limited to the touch panel display.

The information processing apparatus 10 described above has a computer system inside. The process in each configuration of the information processing apparatus 10 described above may be performed by recording a program for realizing the function of each configuration of the information processing apparatus 10 described above on a computer-readable recording medium, and reading the program recorded on the recording medium with the computer system to execute the program. Here, “reading the program recorded on the recording medium into the computer system to execute the program” includes installing the program in the computer system. The “computer system” herein includes the OS or hardware such as peripheral devices. In addition, the “computer system” may include a plurality of computer apparatuses connected via a network including a communication line such as the Internet, a WAN, a LAN, or a dedicated line. In addition, the “computer-readable recording medium” is a portable medium such as a flexible disk, a magneto-optical disk, a ROM, or a CD-ROM, and a storage device such as a hard disk built in the computer system. As described above, the recording medium that stores the program may be a non-transitory recording medium such as a CD-ROM.

In addition, the recording medium also includes an internal or external recording medium that can be accessed from a distribution server to distribute the program. A configuration may be used in which the program is divided into a plurality of programs, downloaded at different timings from each other, and then combined with each configuration of the information processing apparatus 10, or distribution servers for distributing the respective divided programs may be different. Further, the “computer-readable recording medium” includes a medium, which holds the program for a certain period of time, such as a volatile memory (RAM) inside the computer system that serves as a server or a client in a case in which the program is transmitted via the network. The above-described program may be a program for realizing a part of the above-described functions. Further, the program may be a so-called difference file (difference program) in which the above-described functions can be realized in combination with the program already recorded in the computer system.

A part or all of the functions of the information processing apparatus 10 in the above-described embodiments may be realized by an integrated circuit such as a large scale integration (LSI). Each of the functions may be individually realized as a processor, and a part or all of the functions may be integrated into a processor. A method of achieving the integrated circuit is not limited to the LSI, and may be realized by a dedicated circuit or a general-purpose processor. In a case in which advances in a semiconductor technique lead to appearance of an integrated circuit technique that replaces the LSI, an integrated circuit based on the technique may be used.

### DESCRIPTION OF SYMBOLS

10 information processing apparatus
101 first chassis
102 second chassis
103 hinge mechanism
11 communication unit
12 RAM
13 storage unit
14 speaker
15 display unit
16 camera
150 display
155 touch sensor
161 first acceleration sensor
162 second acceleration sensor
17 hall sensor
18 control unit
19 external connection terminal
181 display selection icon display processing unit
182 display selection processing unit
183 layout selection icon display processing unit
184 layout selection processing unit
185 display layout change unit

What is claimed is:

1. An information processing apparatus comprising:
a memory configured to store a program of an application; and
a processor configured to perform control of arranging and displaying windows of the running application in a screen area of a display by executing the program of the application stored in the memory, wherein
the processor is configured to:
perform a display control process of arranging the windows by splitting the screen area of the display into a plurality of display areas, and
in the display control process,
when arranging a first window of the windows in one display area of the plurality of display areas, arrange thumbnail images corresponding to one or a plurality of second windows other than the first window in a display area other than the one display area of the plurality of display areas, and
determine the display area in which the thumbnail images are to be arranged with respect to the one display area in which the first window is to be arranged, in a certain arrangement order.

2. The information processing apparatus according to claim 1, wherein
in the display control process, even when any of the windows is already arranged in the display area in which the thumbnail images are to be arranged, which is determined in the certain arrangement order, the processor preferentially arranges the thumbnail images in the display area.

3. The information processing apparatus according to claim 2, wherein
the certain arrangement order is an order in a clockwise order.

4. The information processing apparatus according to claim 2, wherein
the certain arrangement order is an order in a counterclockwise order.

5. The information processing apparatus according to claim 2, wherein
in the display control process, when the windows are arranged by splitting the screen area of the display into two upper and lower display areas, the processor arranges the thumbnail images in a lower second display area of the two split display areas when arranging the first window in an upper first display area, and arranges the thumbnail images in the first display area when arranging the first window in the second display area.

6. The information processing apparatus according to claim 2, wherein
in the display control process, when the windows are arranged by splitting the screen area of the display into two left and right display areas, the processor arranges the thumbnail images in a right second display area of the two split display areas when arranging the first window in a left first display area, and arranges the thumbnail images in the first display area when arranging the first window in the second display area.

7. The information processing apparatus according to claim 2, wherein
in the display control process, when the windows are arranged by splitting the screen area of the display into three display areas by splitting the screen area into two upper and lower display areas and further splitting the split lower display area into two display areas, the processor arranges the thumbnail images in a lower right second display area of the three split display areas when arranging the first window in an upper first display area, arranges the thumbnail images in a lower left third display area when arranging the first window in the second display area, and arranges the thumbnail images in the first display area when arranging the first window in the third display area.

8. The information processing apparatus according to claim 2, wherein
in the display control process, when the windows are arranged by splitting the screen area of the display into three display areas by splitting the screen area into two upper and lower display areas and further splitting the split lower display area into two display areas, the processor arranges the thumbnail images in a lower left second display area of the three split display areas when arranging the first window in an upper first display area, arranges the thumbnail images in a lower right third display area when arranging the first window in the second display area, and arranges the thumbnail images in the first display area when arranging the first window in the third display area.

9. The information processing apparatus according to claim 2, wherein
in the display control process, when the windows are arranged by splitting the screen area of the display into three display areas by splitting the screen area into two upper and lower display areas and further splitting the split upper display area into two display areas, the processor arranges the thumbnail images in an upper right second display area of the three split display areas when arranging the first window in an upper left first display area, arranges the thumbnail images in a lower third display area when arranging the first window in the second display area, and arranges the thumbnail images in the first display area when arranging the first window in the third display area.

10. The information processing apparatus according to claim 2, wherein
in the display control process, when the windows are arranged by splitting the screen area of the display into three display areas by splitting the screen area into two upper and lower display areas and further splitting the split upper display area into two display areas, the processor arranges the thumbnail images in a lower second display area of the three split display areas when arranging the first window in an upper left first display area, arranges the thumbnail images in an upper right third display area when arranging the first window in the second display area, and arranges the thumbnail images in the first display area when arranging the first window in the third display area.

11. The information processing apparatus according to claim 2, wherein
in the display control process, when the windows are arranged by splitting the screen area of the display into three display areas by splitting the screen area into two left and right display areas and further splitting the split right display area into two display areas, the processor arranges the thumbnail images in a right upper second display area of the three split display areas when arranging the first window in a left first display area, arranges the thumbnail images in a right lower third display area when arranging the first window in the second display area, and arranges the thumbnail images in the first display area when arranging the first window in the third display area.

12. The information processing apparatus according to claim 2, wherein
in the display control process, when the windows are arranged by splitting the screen area of the display into three display areas by splitting the screen area into two left and right display areas and further splitting the split right display area into two display areas, the processor arranges the thumbnail images in a right lower second display area of the three split display areas when arranging the first window in a left first display area, arranges the thumbnail images in a right upper third display area when arranging the first window in the second display area, and arranges the thumbnail images in the first display area when arranging the first window in the third display area.

13. The information processing apparatus according to claim 2, wherein
in the display control process, when the windows are arranged by splitting the screen area of the display into three display areas by splitting the screen area into two left and right display areas and further splitting the split left display area into two display areas, the processor arranges the thumbnail images in a right second display area of the three split display areas when arranging the first window in a left upper first display area, arranges the thumbnail images in a left lower third display area when arranging the first window in the second display area, and arranges the thumbnail images in the first display area when arranging the first window in the third display area.

14. The information processing apparatus according to claim 2, wherein
in the display control process, when the windows are arranged by splitting the screen area of the display into three display areas by splitting the screen area into two left and right display areas and further splitting the split left display area into two display areas, the processor arranges the thumbnail images in a left lower second display area of the three split display areas when arranging the first window in a left upper first display area, arranges the thumbnail images in a right third display area when arranging the first window in the second display area, and arranges the thumbnail images in the first display area when arranging the first window in the third display area.

15. The information processing apparatus according to claim 2, wherein
in the display control process, when the windows are arranged by splitting the screen area of the display into four upper, lower, left, and right display areas, the processor arranges the thumbnail images in a right upper second display area of the four split display areas when arranging the first window in a left upper first display area, arranges the thumbnail images in a right lower third display area when arranging the first window in the second display area, arranges the thumbnail images in a left lower fourth display area when arranging the first window in the third display area, and arranges the thumbnail images in the first display area when arranging the first window in the fourth display area.

16. The information processing apparatus according to claim 2, wherein
in the display control process, when the windows are arranged by splitting the screen area of the display into four upper, lower, left, and right display areas, the processor arranges the thumbnail images in a left lower second display area of the four split display areas when arranging the first window in a left upper first display area, arranges the thumbnail images in a right lower third display area when arranging the first window in the second display area, arranges the thumbnail images in a right upper fourth display area when arranging the first window in the third display area, and arranges the thumbnail images in the first display area when arranging the first window in the fourth display area.

17. The information processing apparatus according to claim 2, wherein
in the display control process, when the windows are arranged by splitting the screen area of the display into three display areas in a left-right direction, the processor arranges the thumbnail images in a central second display area of the three split display areas when arranging the first window in a left first display area, arranges the thumbnail images in a right third display area when arranging the first window in the second display area, and arranges the thumbnail images in the first display area when arranging the first window in the third display area.

18. The information processing apparatus according to claim 2, wherein
in the display control process, when the windows are arranged by splitting the screen area of the display into three display areas in a left-right direction, the processor arranges the thumbnail images in a central second display area of the three split display areas when arranging the first window in a right first display area, arranges the thumbnail images in a left third display area when arranging the first window in the second display area, and arranges the thumbnail images in the first display area when arranging the first window in the third display area.

19. The information processing apparatus according to claim 2, wherein
in the display control process, when the windows are arranged by splitting the screen area of the display into three display areas in an up-down direction, the processor arranges the thumbnail images in a central second display area of the three split display areas when arranging the first window in an upper first display area, arranges the thumbnail images in a lower third display area when arranging the first window in the second display area, and arranges the thumbnail images in the first display area when arranging the first window in the third display area.

20. The information processing apparatus according to claim 2, wherein
in the display control process, when the windows are arranged by splitting the screen area of the display into three display areas in an up-down direction, the processor arranges the thumbnail images in a central second display area of the three split display areas when arranging the first window in a lower first display area, arranges the thumbnail images in an upper third display area when arranging the first window in the second display area, and arranges the thumbnail images in the first display area when arranging the first window in the third display area.

21. A control method in an information processing apparatus including a memory configured to store a program of an application, and a processor configured to perform control of arranging and displaying windows of the running application in a screen area of a display by executing the program of the application stored in the memory,
the method comprising:
via the processor,
a step of splitting the screen area of the display into a plurality of display areas and arranging a first window of the windows in one display area of the plurality of display areas; and
a step of arranging thumbnail images corresponding to one or a plurality of second windows other than the first window in a display area other than the one display area of the plurality of display areas; wherein
the display area in which the thumbnail images are to be arranged is determined in a certain arrangement order with respect to the one display area in which the first window is to be arranged.
